(19) United States
(12) Patent Application Publication
(10) Pub. No.: US 2004/0119201 A1
(43) Pub. Date: Jun. 24, 2004

(54) Apparatus and method for manufacturing plastic products with EMI/RFI/ESD shield

(75) Inventors: Paul C. Burton, Kentwood, MI (US); William M. Matich, South Lyon, MI (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Siegel-Robert, Inc.

(21) Appl. No.: 10/618,907

(22) Filed: Jul. 14, 2003

Related U.S. Application Data
(60) Provisional application No. 60/395,686, filed on Jul. 12, 2002.

(51) Int. Cl. B29C 70/40

(52) U.S. Cl. 264/259; 425/126.1; 425/3; 425/414; 425/444; 425/139; 264/339

(57) ABSTRACT

Apparatus for manufacturing molded products with an EMI/RFI/ESD shield. The apparatus includes shaping apparatus for automatically shaping a mesh blank into a mesh insert on a fixture, and a robot for removing the insert from the fixture and placing it in a molding machine in preparation for molding the insert into a molded product. Also disclosed is a method for manufacturing molded products involving the steps of automatically forming the blank into a mesh insert and automatically transferring the insert to a molding machine using a robot. A holding tool may be provided for the robot to use in transferring the insert to the molding machine.

### BACKGROUND OF THE INVENTION

This invention relates generally to molded plastic products and, more particularly, to apparatus and methods for making such products with molded-in wire mesh inserts for shielding against electromagnetic interference (EMI), radio frequency interference (RFI) and/or electrostatic discharge (ESD).

Reference may be made to U.S. Pat. No. 6,054,647 (issued to Ridener, Apr. 25, 2000), which is incorporated by reference herein for all purposes, for background information relating to electromagnetic shielding for plastic parts.

### SUMMARY OF THE INVENTION

One embodiment of the present invention is an apparatus for manufacturing plastic products to have EMI/ESD/RFI protection. The apparatus includes a shaping apparatus for shaping a mesh blank into a mesh insert on a fixture. The apparatus also includes a robot for removing the shaped mesh insert from the fixture, transferring the insert to a molding machine, and placing the insert on a mold core of the machine in preparation for a molding operation in which the insert is molded into a molded product.

Another embodiment of the present invention is a holding tool for use by a robot to transfer mesh inserts to a molding machine and to transfer molded products away from the molding machine. The holding tool includes a base, a mesh insert holder attached to the base, and a molded product holder also attached to the base.

According to a method of the present invention for manufacturing molded products to have EMI/ESD/RFI protection, a mesh blank is automatically shaped on a fixture into a mesh insert. Then a robot is operated to (1) remove the shaped mesh insert from the fixture, (2) transfer the insert to a molding machine, and (3) place the insert on a mold core of the machine in preparation for a molding operation in which the insert is molded into a molded product.

### BRIEF DESCRIPTION OF THE DRAWINGS

FIG. 1 is a plan view of one embodiment of an apparatus of the present invention alongside a molding machine;

FIG. 2 is a side elevation of the apparatus and molding machine shown in FIG. 1;

FIG. 3 is an enlarged plan view of a portion of the apparatus shown in FIGS. 1 and 2 showing feeding apparatus, a press, forming apparatus, and shaping apparatus;

FIG. 4 is a side elevation of the feeding apparatus, press, forming apparatus, and shaping apparatus shown in FIG. 3;

FIG. 5 is an enlarged end view of the press, forming apparatus, and shaping apparatus shown in FIGS. 3 and 4;

FIG. 6 is an enlarged plan view of the feeding apparatus shown in FIGS. 1-5;

FIG. 7 is a side elevation of the feeding apparatus shown in FIG. 6;

FIG. 8 is an end view of the feeding apparatus shown in FIGS. 6 and 7;

FIG. 9 is a horizontal sectional view of the taken in the plane 9-9 on FIG. 2 showing the lower platen;

FIG. 10 is a sectional view of the upper and lower platens of the press shown in FIG. 9 taken in the plane 10-10 on FIG. 9;

FIG. 11 is a sectional view of the upper and lower platens of the press taken in the plane 11-11 on FIG. 9;

FIG. 12 is a plan view of a mesh blank that may be cut by the press shown in FIGS. 9-11;

FIG. 13 is a plan view of a forming apparatus having four spokes;

FIG. 14 is an enlarged end view of a portion of the forming apparatus shown in FIG. 13;

FIG. 15 is an enlarged side view of the shaping apparatus shown in FIGS. 1-5;

FIG. 16 is an end view of the shaping apparatus shown in FIG. 15;

FIG. 17 is a perspective view of a mesh insert that may be formed by folding or bending the mesh blank shown in FIG. 12;

FIG. 18 is a perspective view of a holding tool for the robot arm;

FIG. 19 is a rear view of the holding tool shown in FIG. 18;

FIG. 20 is a plan view of the holding tool shown in FIG. 18;

FIG. 21 is a side elevation of a robot arm in the process of transporting a mesh insert from the apparatus shown in FIGS. 1-5 to the molding machine;

FIG. 22 is a side elevation of a robot arm in the process of placing the mesh insert into the molding machine;

FIG. 23 is an enlarged perspective view of a portion of the forming apparatus and a portion of a shaping apparatus about to begin forming a mesh blank into a mesh insert;

FIG. 24 is an enlarged perspective view of the portion of the forming apparatus and the portion of the shaping apparatus shown in FIG. 23 just after the hold down plate has moved down to hold the mesh blank in place;

FIG. 25 is an enlarged perspective view of the portion of the forming apparatus and the portion of the shaping apparatus shown in FIG. 23 just after the end swipes have bent the end flaps over the fixture;

FIG. 26 is an enlarged perspective view of the portion of the forming apparatus and the portion of the shaping apparatus shown in FIG. 23 just after the lower assembly has moved into position in preparation for forming tabs;

FIG. 27 is an enlarged perspective view of the portion of the forming apparatus and the portion of the shaping apparatus shown in FIG. 23 just after the tab shaping members have formed the tabs;

FIG. 28 is an enlarged perspective view of the portion of the forming apparatus and the portion of the shaping apparatus shown in FIG. 23 just after the tab forming members have returned to their original position after forming the tabs;

FIG. 29 is an enlarged perspective view of the portion of the forming apparatus and the portion of the shaping apparatus shown in FIG. 23 just after the side swipes have bent the side flaps to form side walls;

FIG. 30 is an enlarged perspective view of the portion of the forming apparatus and the portion of the shaping apparatus shown in FIG. 23 with a completely formed mesh insert on the fixture;

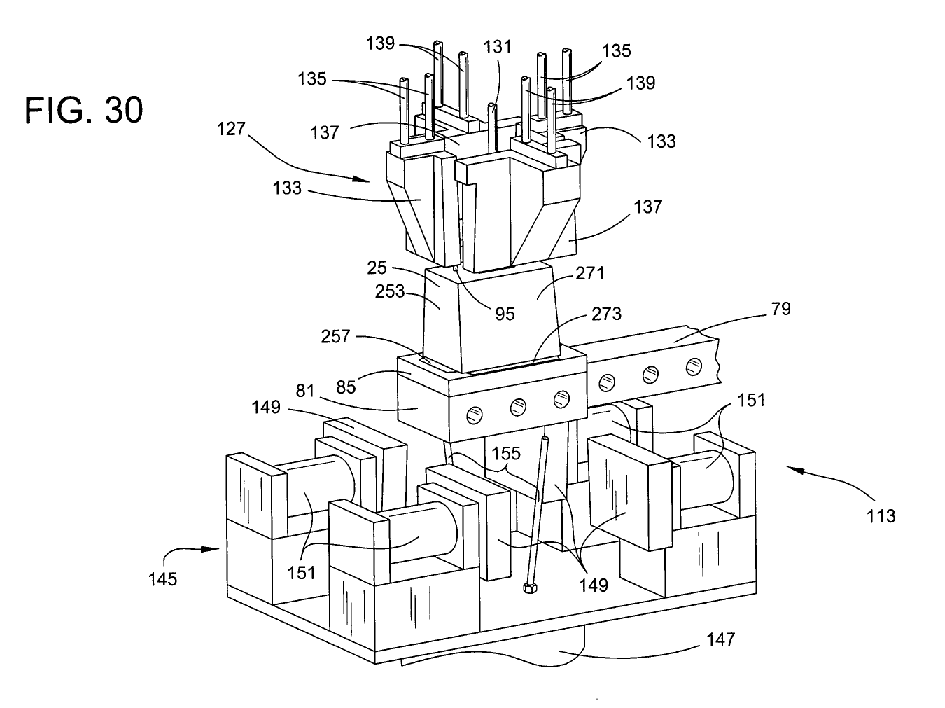

FIG. 31 is an enlarged plan view of a robot arm ready to remove a molded product from a mold core;

FIG. 32 is an enlarged plan view of a robot arm removing a molded product from a mold core;

FIG. 33 is an enlarged plan view of a robot arm placing a mesh insert on a mold core;

FIG. 34 is a perspective view of a molded product made according to the present invention;

FIG. 35 is a cross sectional view of the molded product shown in FIG. 34 taken through the plane 35—35 shown on FIG. 34; and

FIG. 36 is a schematic diagram of a pneumatic circuit that may be used to supply compressed air to pneumatic actuators that may be used in an apparatus of the present invention.

Corresponding reference numbers are used to identify corresponding parts throughout the drawings.

### DETAILED DESCRIPTION

Generally, as will be described, an apparatus of the present invention is operable to automatically form mesh inserts of electrically conductive material (e.g., copper), and to robotically load the inserts into the mold of a molding machine which forms plastic products with the mesh inserts molded into the products for shielding against electromagnetic interference (EMI), radio frequency interference (RFI) and/or electrostatic discharge (ESD). The molded products may be robotically unloaded from the molding machine for inspection or other processing.

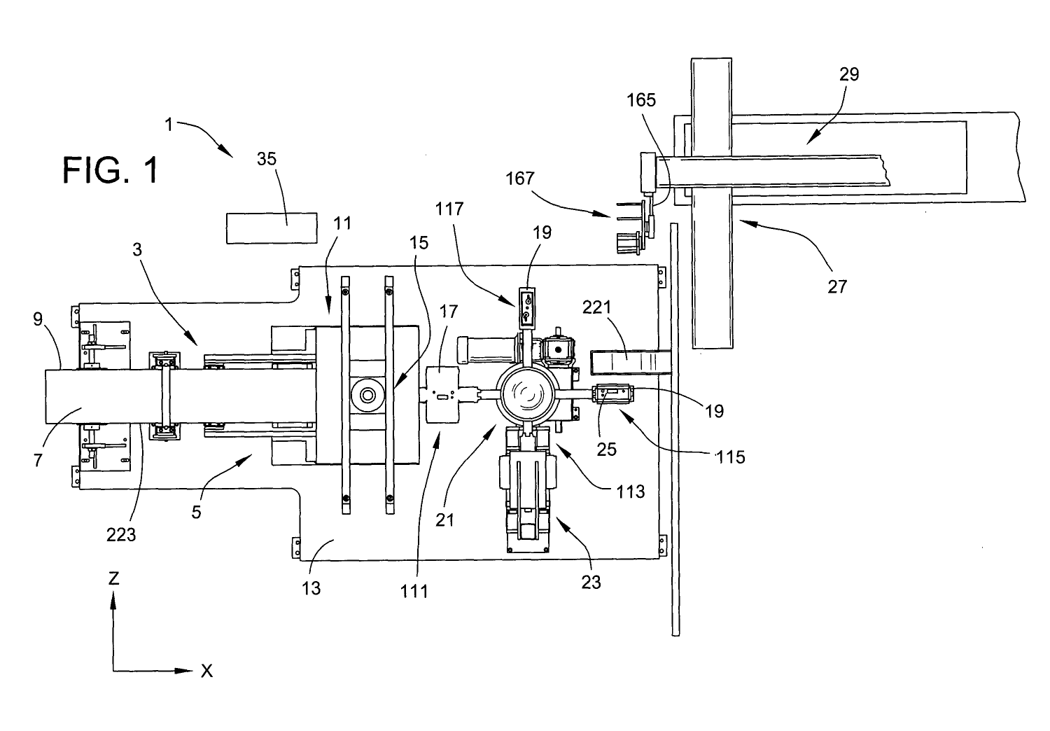

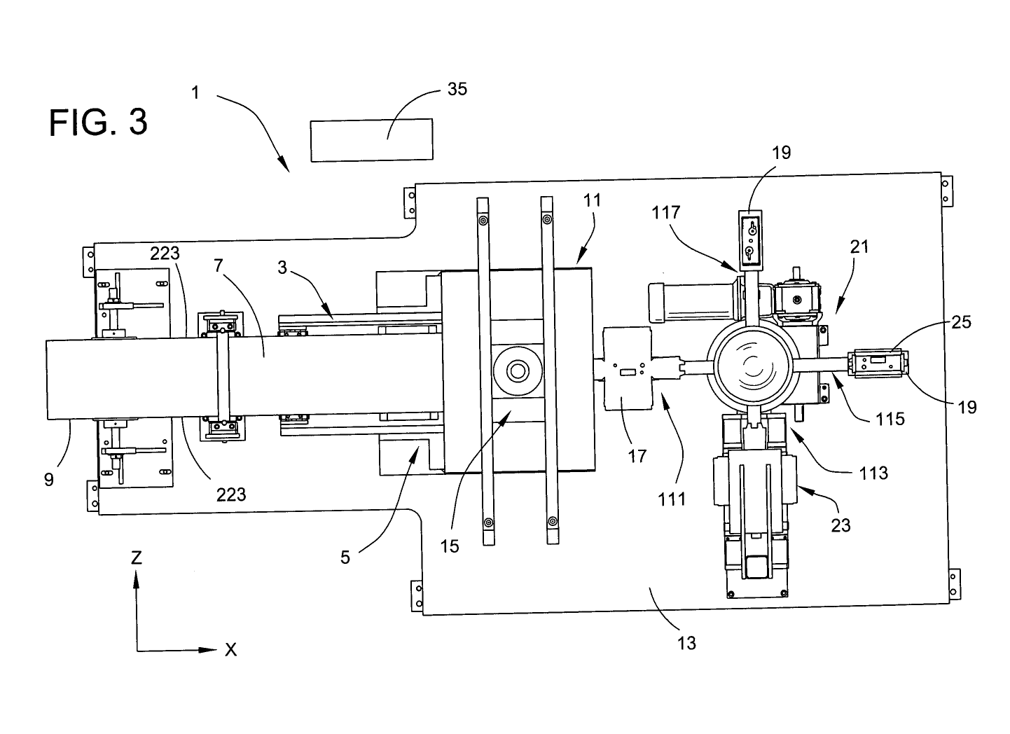

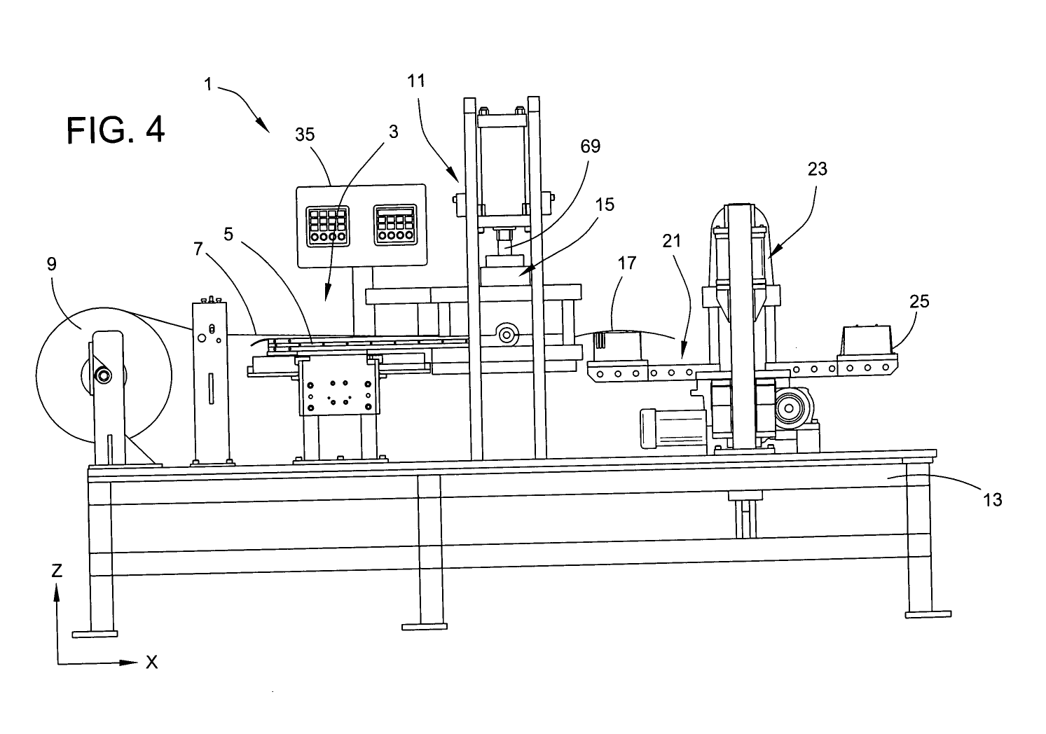

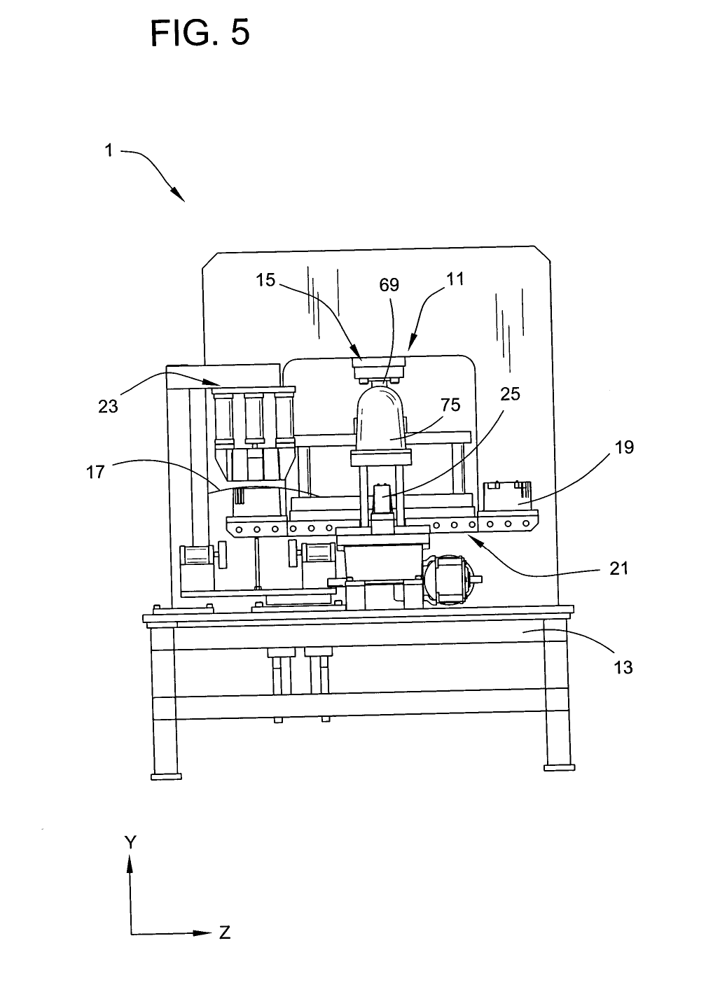

FIGS. 1-5 show one embodiment of apparatus of the present invention. The apparatus (sometimes referred to as a “cell”), generally designated 1, comprises a feeding apparatus 3 at a feeding station 5 for pulling a continuous web of wire mesh 7 from a supply roll 9 and feeding the web 7 to a stamping station 11. As is known to those skilled in the art, a conventional alignment mechanism (not shown) may be provided for helping to keep the web of wire mesh 7 aligned as the feeding apparatus 3 pulls it from the supply roll 9. The wire mesh 7 may be made of any suitable conductor (e.g., copper). The size of the holes in the mesh 7 may vary. One exemplary wire mesh is made of 0.065 inch diameter wires and has between about 30 and 40 wires per inch running in one direction cross-linked with a roughly equal number wires per inch running in a cross (e.g., perpendicular) direction. However, it is possible to use a much finer or courser wire mesh if desired.

A press 15 at the stamping station 11 stamps flat mesh blanks 17 from the web 7. The blanks 17 are automatically placed on a forming apparatus 21 having a forming fixture 19 and delivered to a shaping apparatus 23 which shapes the mesh blanks 17 over the forming fixture 19 to form mesh inserts 25. The cell 1 also includes a robot 27 for picking up the shaped inserts 25, for transferring them to a molding machine 29 (e.g., an injection molding machine), and for unloading molded products from the molding machine. A control system 35 (e.g., computer) controls the operation of the cell 1, the robot 27, and the molding machine 29. A table 13 or similar support may be used to provide a level surface for the various parts of the apparatus.

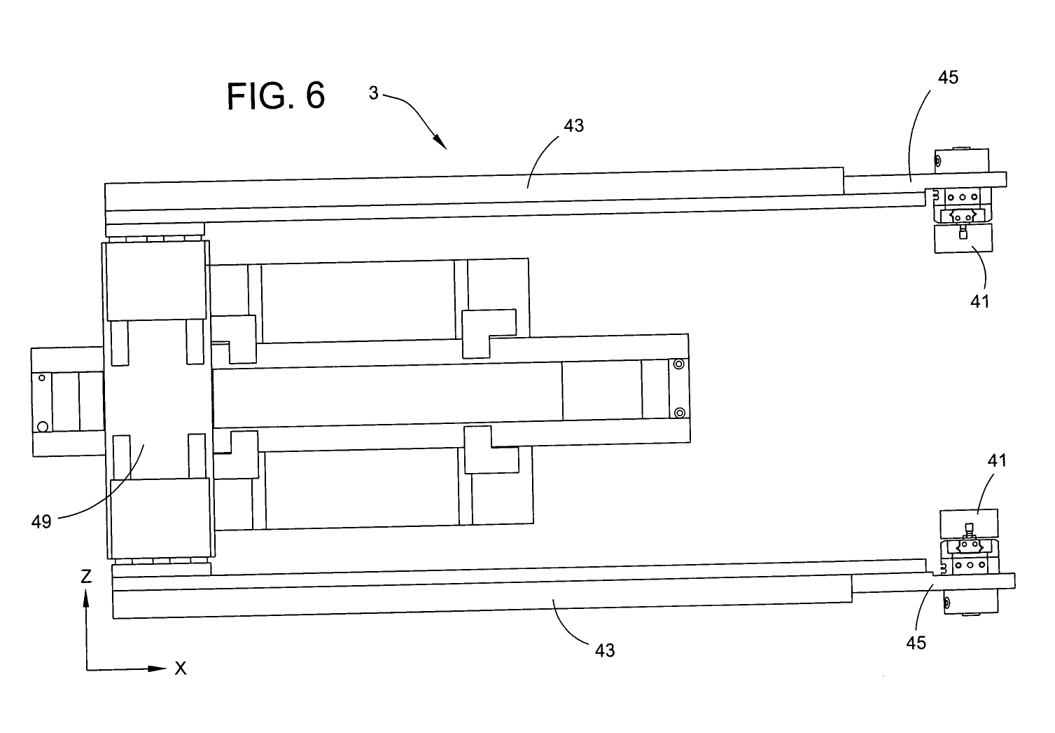

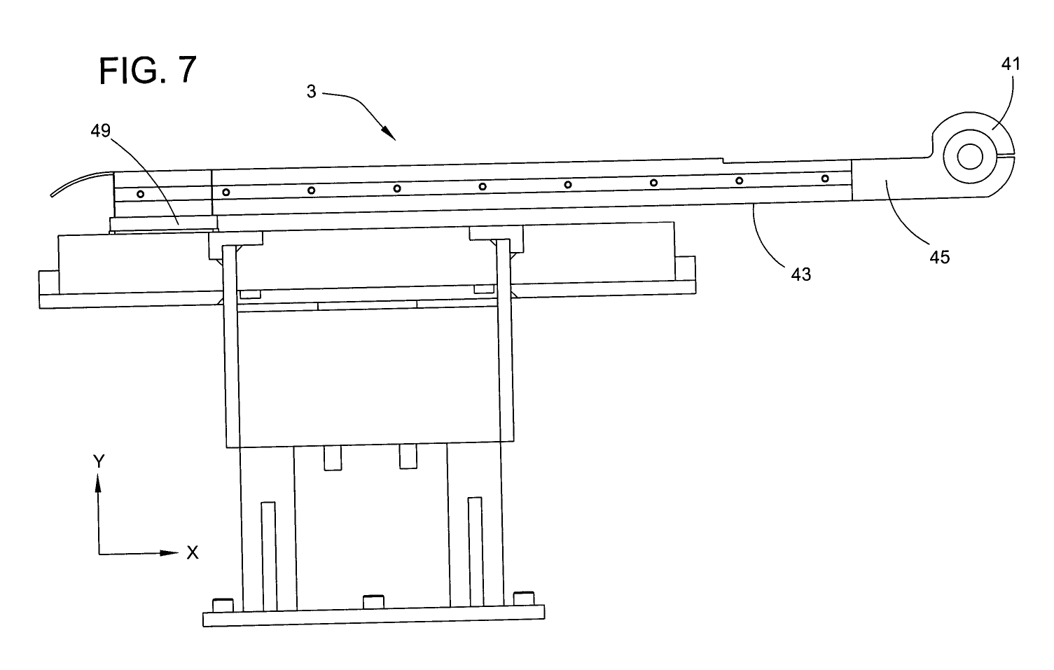

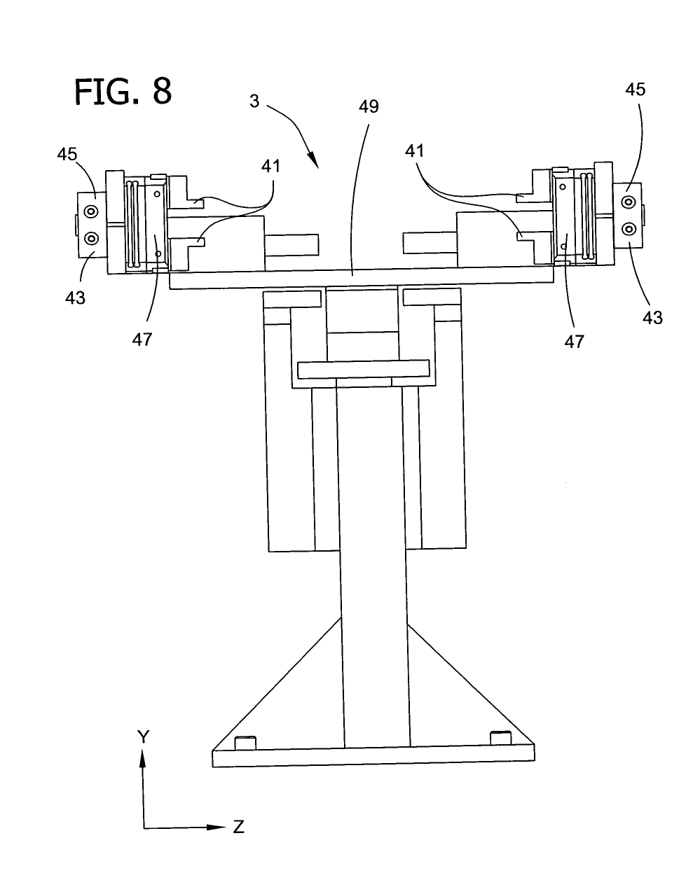

As shown in FIGS. 6-8, the feeding apparatus 3 may comprise, in one embodiment, a pair of jaws 41 or grippers mounted at the forward ends 45 of two arms 43 extending along opposite sides 223 of the web 7, and a mechanism 47 (e.g., pneumatic cylinders) for opening and closing the jaws 41. The arms 43 are mounted on a carriage 49 which is capable of moving the arms in X 51, Y 53 and Z 55 directions relative to the web 7, that is, X being back and forth in a direction generally parallel to the web 7, Y being up and down, and Z being in and out in a direction generally transverse to the web 7. The movements of the carriage 49 and arms 43 are effected by suitable power actuators 57 (e.g., pneumatic cylinders).

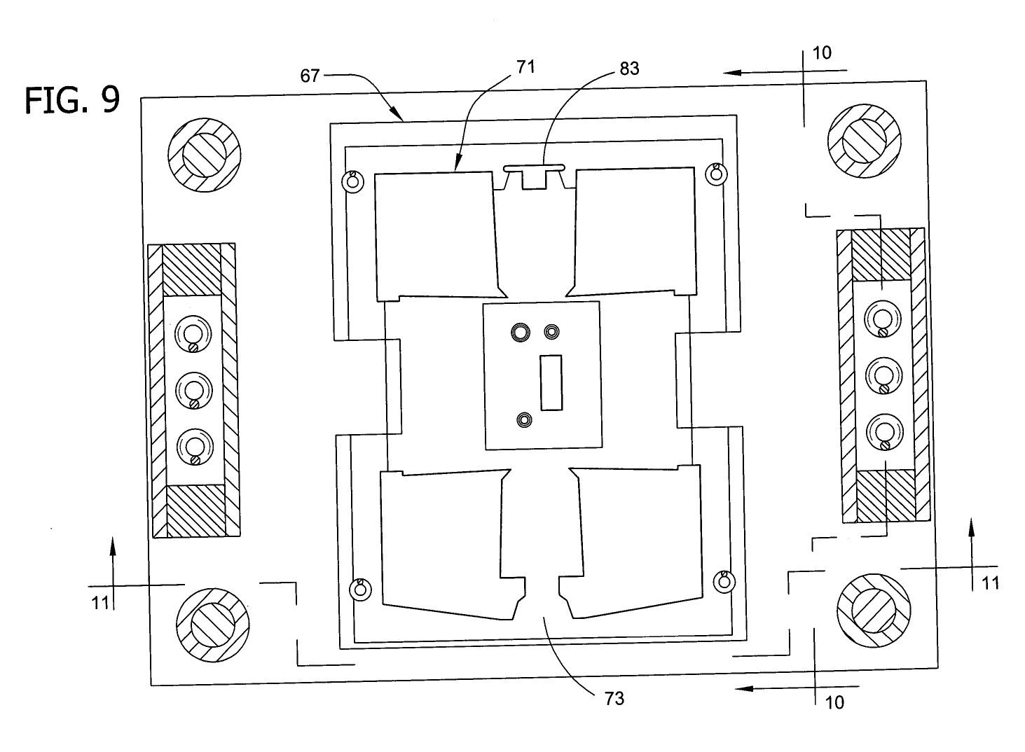

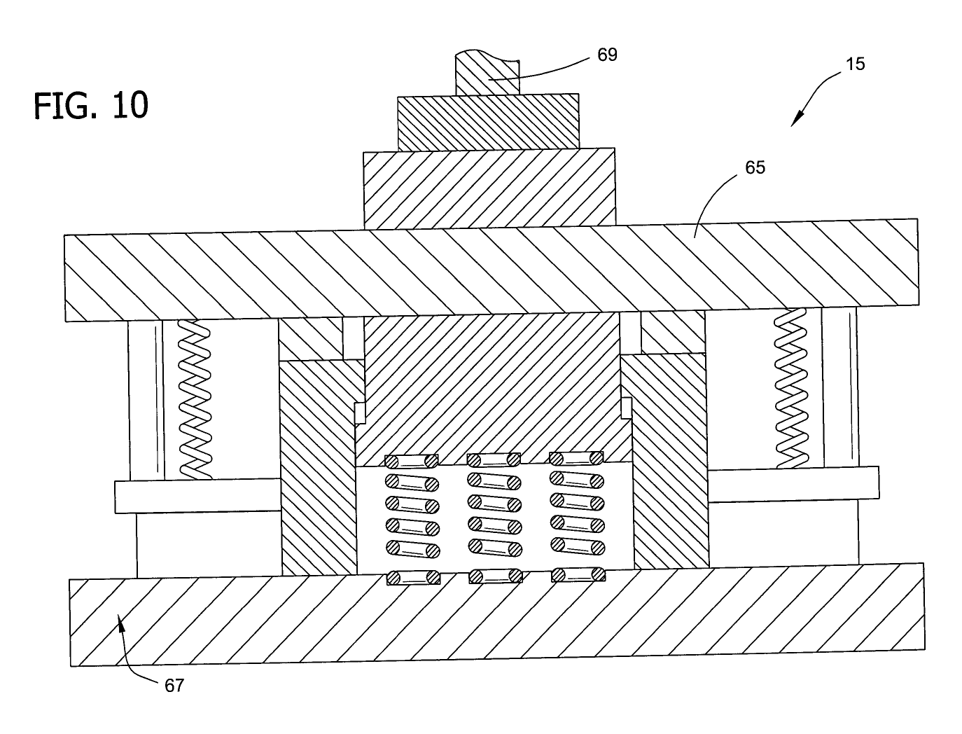

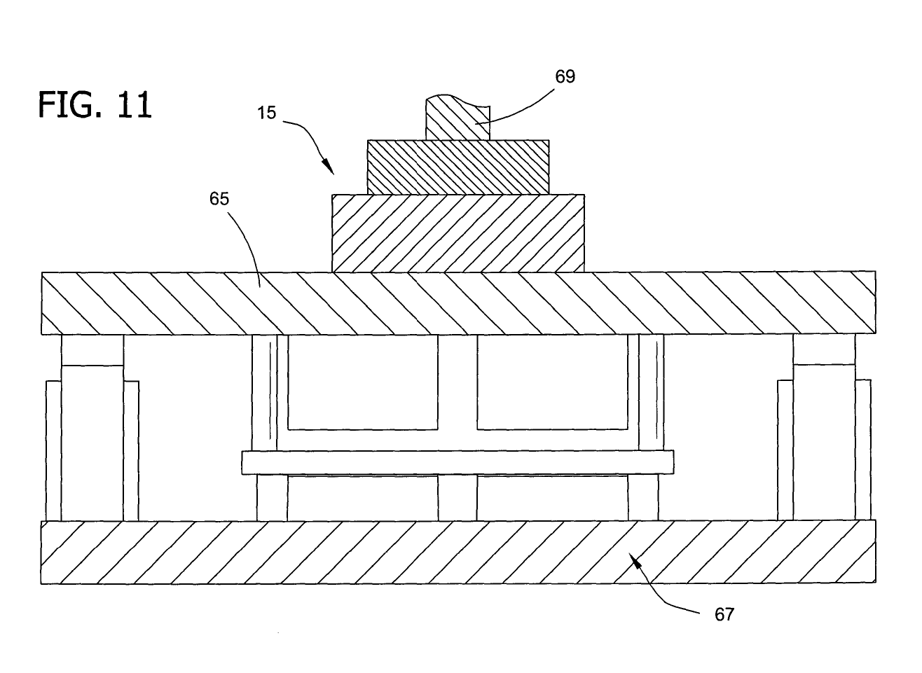

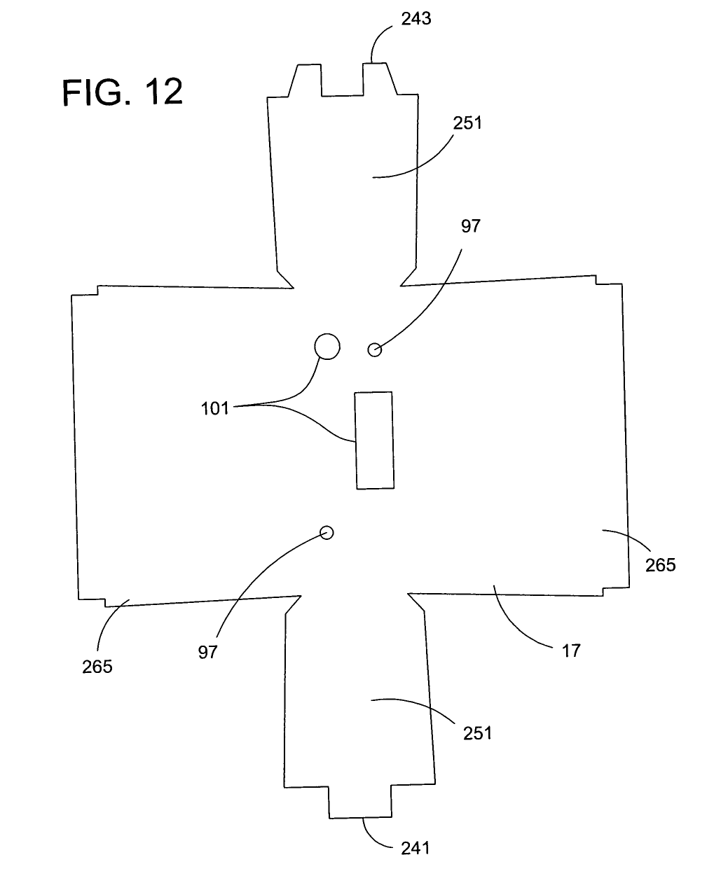

Referring to FIGS. 9-11, the press comprises upper and lower platens 65, 67 (“shoes”) and conventional cutting tooling 71 (e.g., one or more dies) for cutting blanks 17 of appropriate size and shape from the web 7. FIG. 12, for example, shows the outline of a mesh blank 17 that may be cut by the cutting tooling 71 shown in FIG. 9. The mesh blank 17 has two end flaps 251 and two side flaps 265. The mesh blank may include holes 97 (e.g., two holes) for receiving locator pins, as will be described later. Additional holes 101 may be cut in the blank 17 if desired. The mesh blank 17 also has a forward end 243 and a trailing end 241. For reasons that will become apparent, a gap 73 (FIG. 9) is provided in the cutting tooling 71 so that the trailing end 241 of the mesh blank 17 is not severed from the web 7 while the blank 17 is still on the press 15. Instead, as will be described later in more detail, the tooling 71 includes a blank-severing portion 83, which is operable to sever the trailing end 241 of the blank 17 from the web 7 as the next blank 17 is being cut. In one embodiment, the lower platen 67, on which the web 7 has been placed, is stationary and the upper platen 65 is movable in a vertical direction toward and away from the lower platen 67. An actuator 69 (e.g., pneumatic cylinder) may be provided to power movement of the upper platen 65.

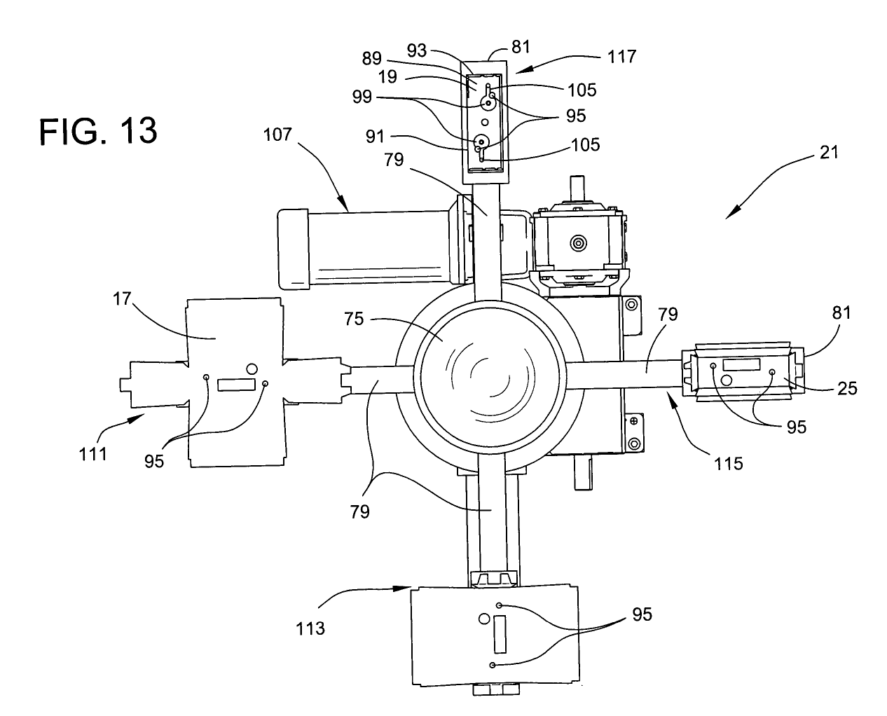

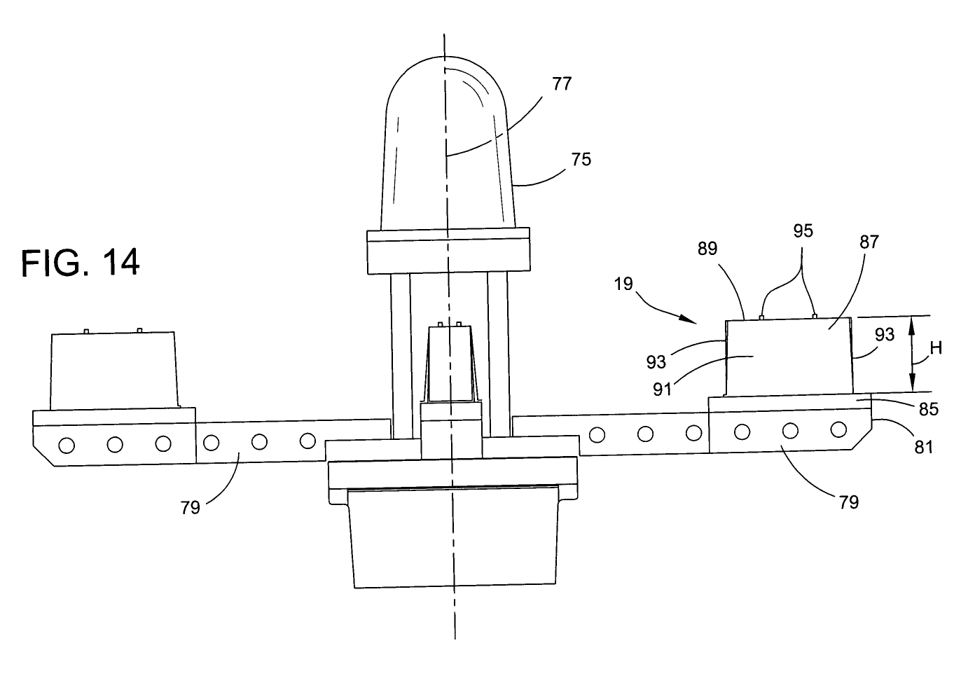

FIGS. 13 and 14 show a forming apparatus 21, which comprises a central hub 75 rotatable about a vertical axis 77, and a plurality of arms or spokes 79 radiating out from the hub 75. For example, four spokes 79 may be provided at 90° intervals. A fixture 19 having a shape corresponding to the shape of the mesh insert 25 to be formed is mounted toward the outer end 81 of each spoke 79 (FIG. 14). For example, the fixture 19 may have a flat rectangular base 85 and a rectangular block 87 on the base 85. The fixture block 87 has an upper surface 89, two opposing side surfaces 91, and two opposing end surfaces 93. Locator pins 95 (e.g., two pins) extend up from the fixture block 87 for reception in holes 97 in the mesh blank 17 to properly locate the mesh blank 17 on the fixture 19. Magnets 99 (e.g., two electro-magnets in FIG. 13) are provided on one or more of the fixture surfaces 89, 91, 93 to hold the blank 17 in place. A suitable drive mechanism 107 (e.g., an electric motor), is provided for indexing the spokes 79 between four positions or stations, namely, a first blank-receiving station 111 adjacent the press 15, a second insert shaping station 113, a third insert loading station 115, and a fourth idle station 117. One or more sensors 105 (e.g., magnetic proximity sensors) are provided for sensing the correct position of the mesh blank 17 and mesh inset 25 on the fixture 19. The sensors 105 are just one example of a plurality of sensors (not shown) that may be stationed at various locations on or in the apparatus 1 to provide feedback to the control system 35 regarding the operation of the apparatus 1.

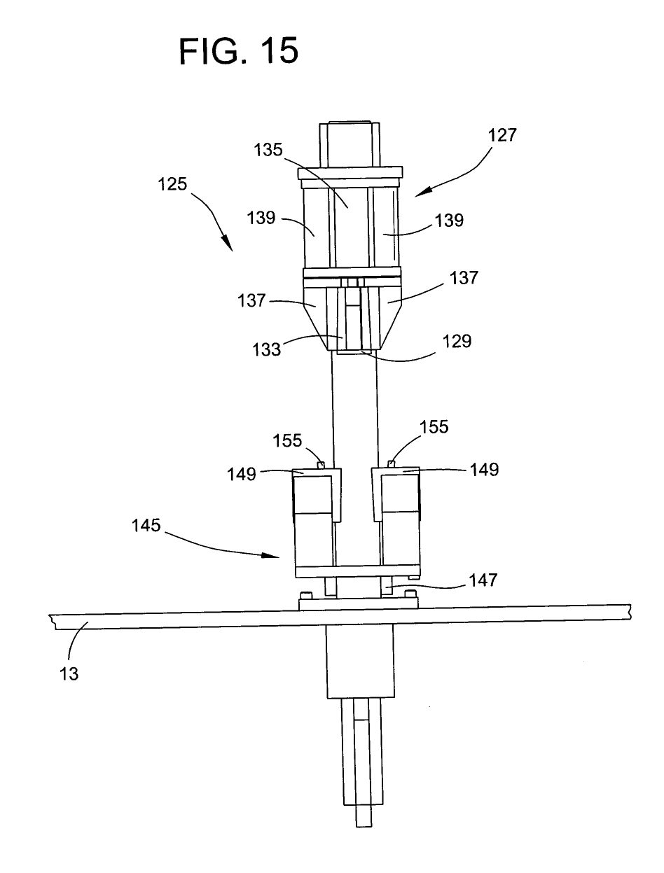

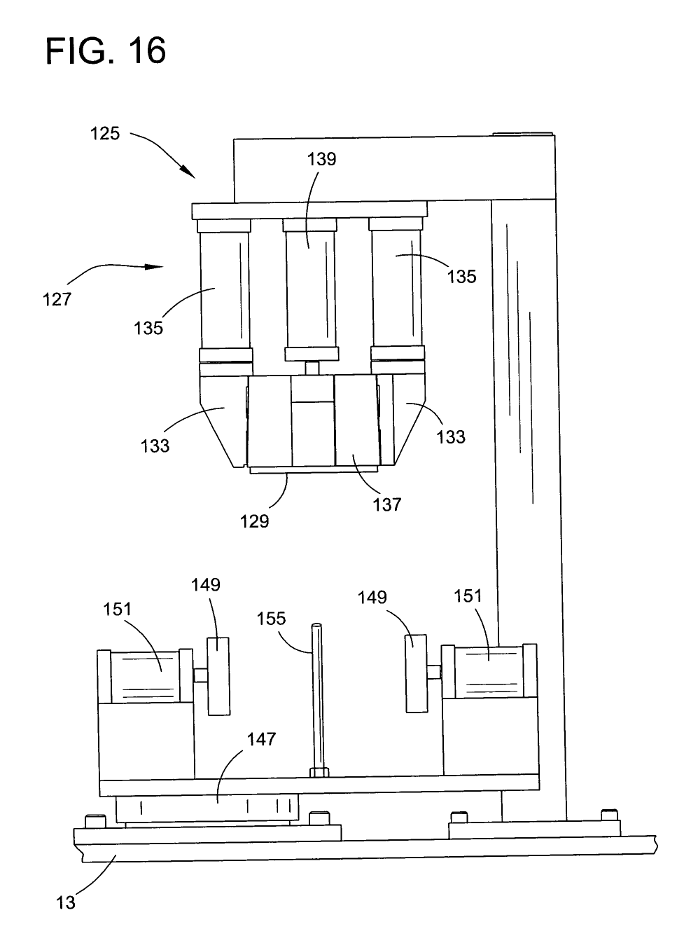

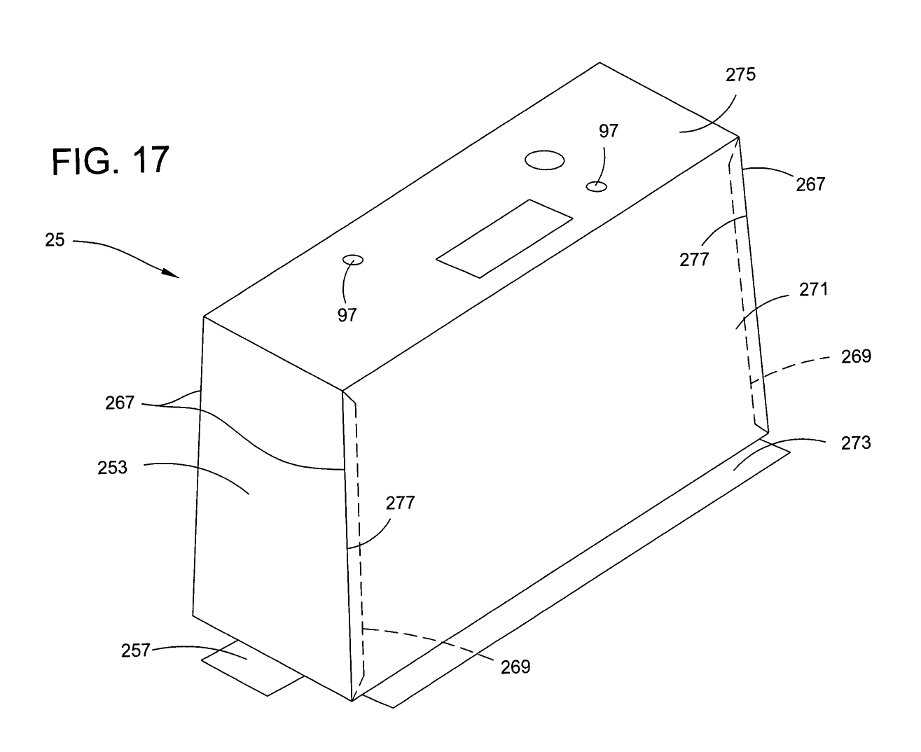

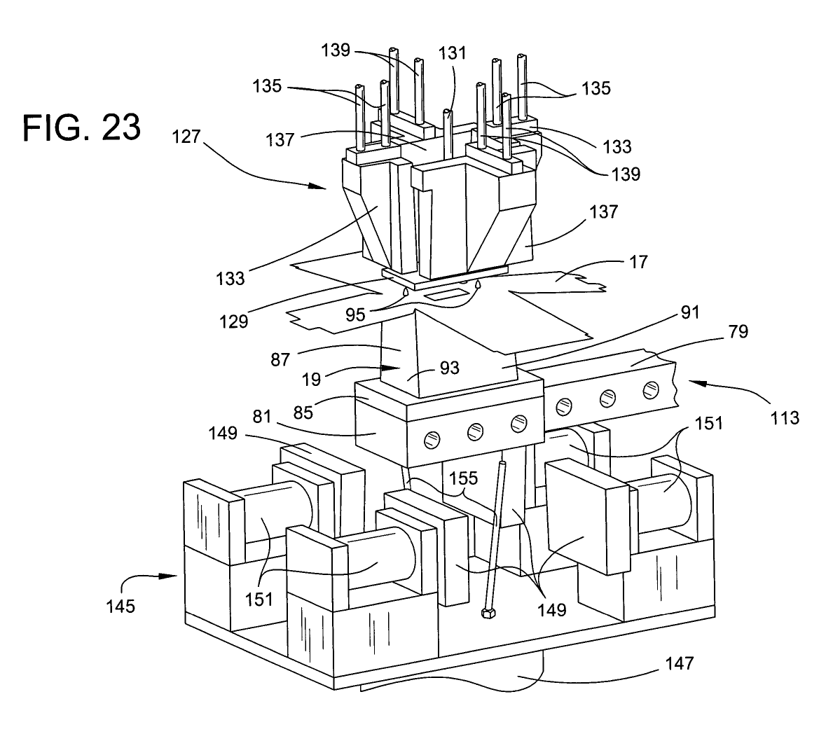

Referring to FIGS. 15 and 16, a shaping apparatus 23 is provided at the second (shaping) station 113 for shaping each blank 17 into a mesh insert 25. The shaping apparatus 23 may include an upper assembly 127 comprising, in one embodiment, a horizontal hold-down plate 129 movable up and down by a power cylinder 131 (shown in FIG. 23), two opposing end shaping members 133 (“end swipes”) at opposite ends of the hold-down plate 129 movable up and down by power cylinders 135, and two opposing side shaping members 137 (“side swipes”) at opposite sides of the hold-down plate 129 movable up and down by power cylinders 139. The shaping apparatus 23 also includes a lower frame 145 (sometimes referred to as a “tab unit”) movable up and down by one or more power actuators 147, and two opposing pairs of tab shaping members 149 on the lower frame 145 movable toward and away from one another by power actuators 151. Two push rods 155 are also fixed to the lower frame 145. Position sensors (e.g., magnetic proximity sensors, not shown) are provided for sensing the positions of the various shaping members 133, 137, 149. Position sensors are also provided for sensing the position of each fixture 19 as it moves from station to station. The shaping apparatus 23 is operable, in a manner to be described below, to form the exemplary mesh blank 17 into the exemplary mesh inset 25 shown in FIG. 17. The mesh insert 25 has a top wall 275, two end walls 253, and two side walls. End wall flanges 257 are provided at the lower edges of the end walls 253. Similarly, side wall flanges 273 are provided at the lower edges of the side walls 271. The end walls 253 also have flanges (“tabs”) 269 along their edges 267 which tuck inside the side walls 271 to provide corners 277 which are completely sealed against EMI/RFI/ESD.

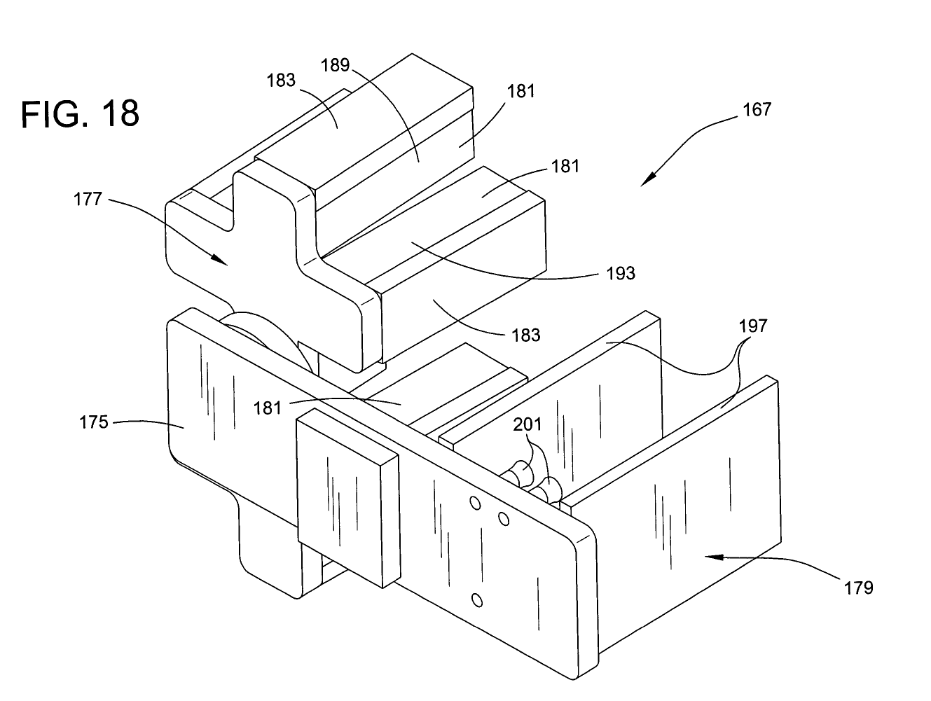

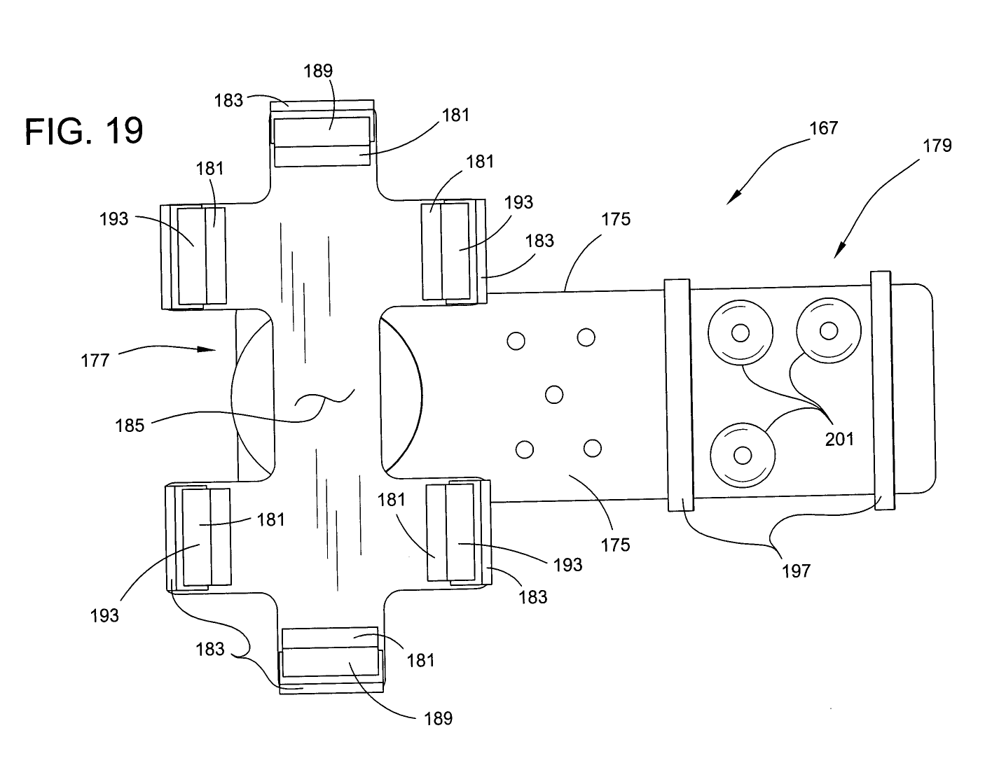

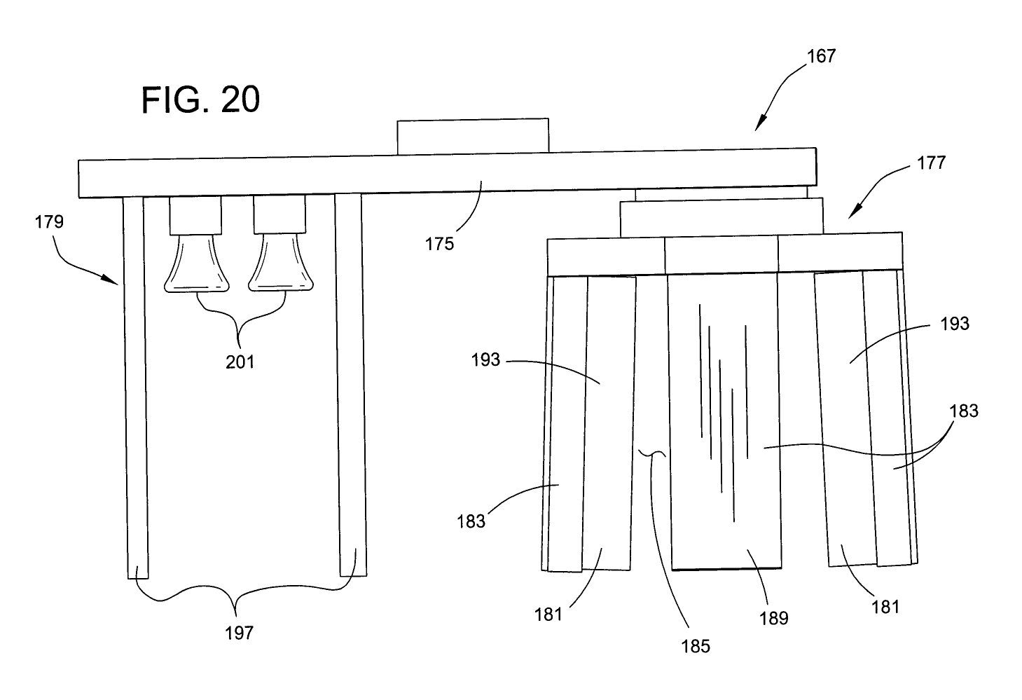

The robot 27 is positioned within reach of the loading station 115 of the forming apparatus 21. The robot 27 includes an arm 165 carrying a holding tool 167, which is shown in FIGS. 18-20. The holding tool 167 comprises a base 175 for attachment to the arm 165, an insert holder 177 and a molded product holder 179, the two holders 177, 179 being positioned side by side on the base 175. The insert holder 177 comprises an array of magnets 181 (e.g., six) on magnet supports 183 attached to the base 175. The magnets 181 are preferably electro-magnets arranged to define a cavity 185 for holding a mesh insert 25. For example, if the mesh insert 25 is going to have a generally rectangular shape, a first group 189 of opposing magnets 181 may be operable to contact the end walls 253 of the insert 25 and a second group 193 of opposing magnets 181 may operable to contact the side walls 271 of the insert 25 (e.g., two magnets on each side wall and one on each end wall). The product holder 179 comprises a pair of parallel plates 197 extending from the base 175 and spaced for receiving a molded product 33 therebetween, and vacuum devices 201 on the base 175 between the plates 197. The robot 27 also includes a conventional frame 169 and mechanism (not shown) for moving the arm 165 between the insert loading station 115 and the molding machine 29.

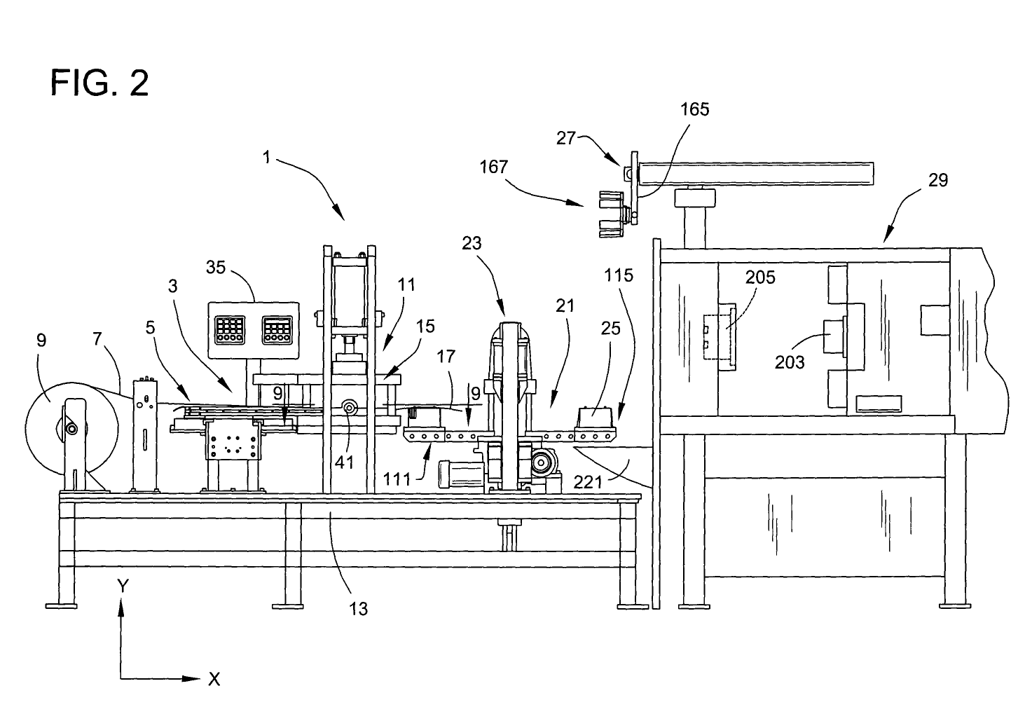

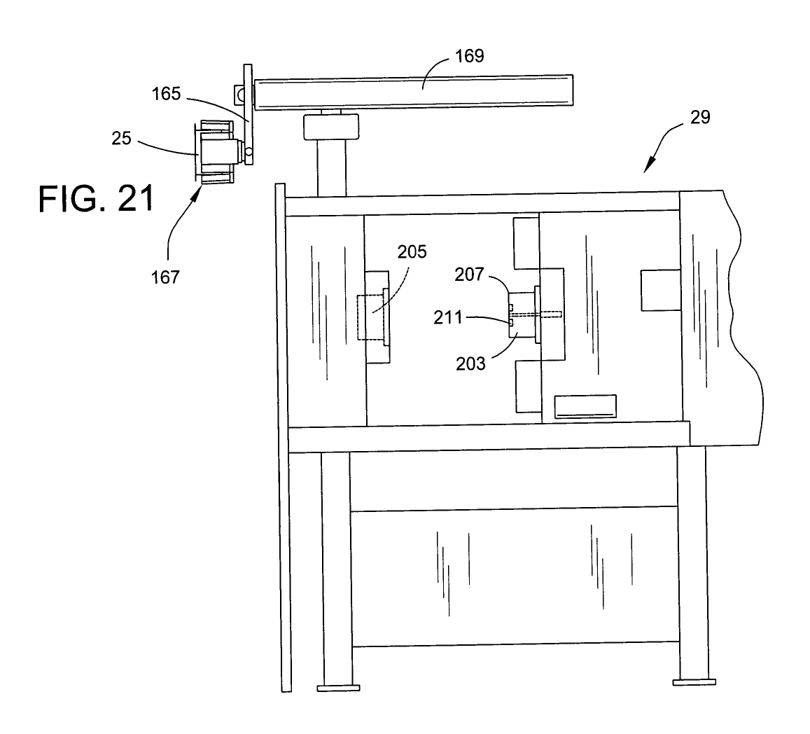

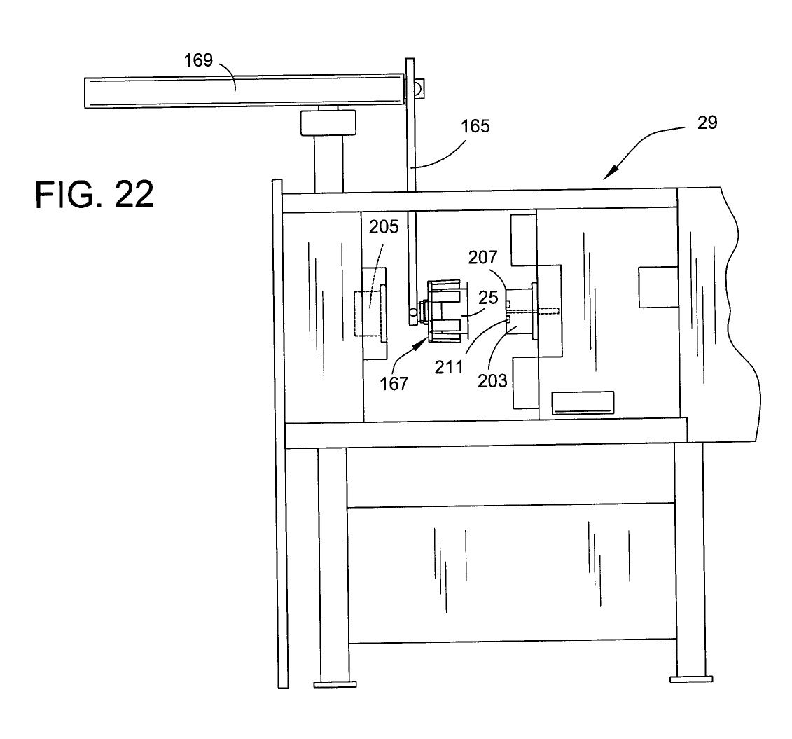

The injection molding machine 29 is positioned within reach of the robot arm 165 as shown in FIGS. 21 and 22, for example. The molding machine 29 comprises a mold core 203 and a mold cavity 205 for receiving the core 203, as will be understood by those skilled in the art. The mold core 203 has an external shape generally corresponding to the shape of the fixtures 19 on the spokes 79 of the forming apparatus 21 and the inside contour of each shaped mesh insert 25. The mold core 203 has magnets 211 (e.g., electromagnets) on it for holding a shaped insert 25 in place on the core 203, as explained below. The construction of the molding machine 29 is otherwise conventional and will not be described in detail. Suffice it to say that as plastic is injected into the mold cavity 205, the plastic flows through the mesh insert 25 so that it becomes an integral “molded-in” part of the finished product to provide effective and reliable protection against EMI/ESD/RFI. As shown in FIGS. 1 and 2, a product conveyance chute 221 may be provided adjacent the loading station 115 (or at another convenient location) for receiving molded products from the robot 27 and for transferring the products to a suitable location (not shown) for inspection and, if necessary, further processing.

The operation of the apparatus 1 will now be described. With the arms 43 of the feeding apparatus 3 positioned immediately adjacent opposite side edges 223 (FIGS. 1-5) of the web 7, the grippers 41 are actuated to close on the mesh web 7. The press 15 closes to die cut a blank 17 from the web 7 and opens upon completion of the cutting. The carriage 49 and arms 43 of the feeding apparatus 3 (FIGS. 6-8) are then raised to lift a partially cut blank 17 from the press 15, and the carriage 49 advances in a forward direction 51 to move the partially cut blank 17 to a position above a fixture 19 at the first station 111 (FIGS. 1-5). At this point, the blank 17 (FIG. 12) cut from the web is still connected to the web 7 at its trailing (back) end 241 because of the gap 73 in the tooling 71 (FIG. 9). Thus, forward movement of the arms 43 functions to pull more web 7 from the supply roll 9 and to advance a section of raw uncut web 7 into the press 15 over the lower platen 67 of the press 15. The carriage 49 and arms 43 are then lowered to place the blank 17 on the locating pins 95 of the fixture block 87 at the first station 111 and to place the raw web 7 on the lower platen 67, following which the grippers 41 are opened and the arms 43 move away from one another to release the web 7. The carriage 43 is then raised and moved in a rearward direction 51 to a position where the grippers 41 are at their home position adjacent the press 15 (FIG. 2), at which point the arms 43 move toward one another and the grippers 41 close to grip the web 7 in preparation for the next blank 17 to be cut. As the next blank is cut, the connection between the trailing end 241 of the mesh blank 17 and the web 7 is severed by the severing portion 83 of the tooling 71 (FIG. 9) and the cycle repeats. Those skilled in the art will understand that one feed mechanism may be used to feed raw web to the press 15 and a second mechanism used to move the mesh blank 17 to the forming station 21 without departing from the scope of this invention. However, it will also be recognized that certain advantages may be achieved by providing a single feed mechanism to perform both tasks, as described above.

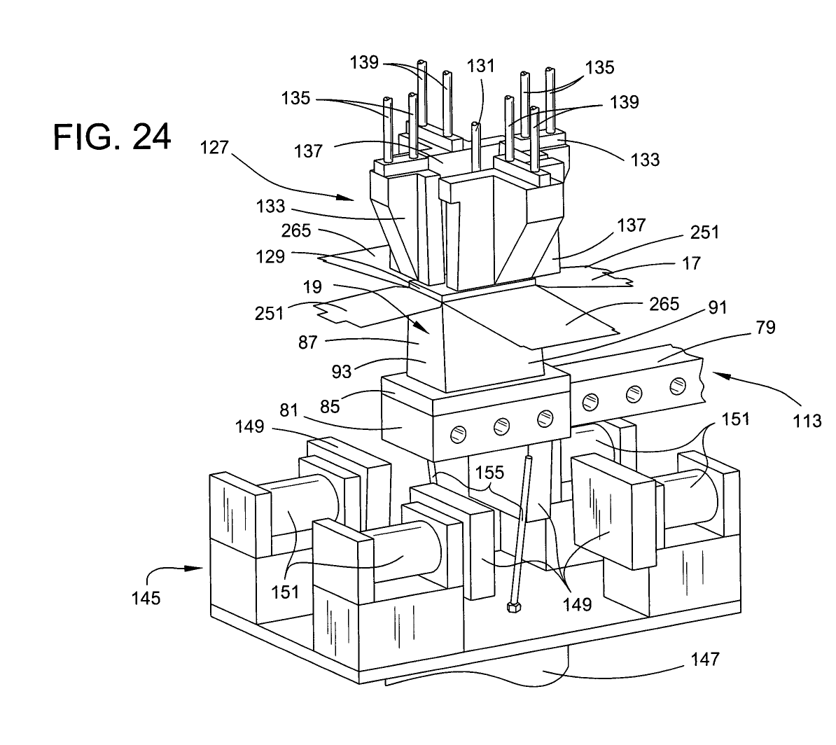

After the blank 17 at the first station 111 has been severed from the mesh web 7, the hub 75 of the forming apparatus 21 (FIGS. 13 and 14) is rotated to index the blank 17 from the first (blank-receiving) station 111 to the second (forming) station 113. The shaping apparatus 23 (FIGS. 15 and 16) then forms the mesh blank 17 into a mesh insert 25. In order to form the exemplary mesh insert 25, the hold-down plate 129 is lowered as shown in FIG. 24 to hold the mesh blank 17 securely against the upper surface 89 of the fixture 19, as confirmed by the sensor 105 in the fixture 19. The locating pins 95 may retract into the fixture block 87 to provide a space for the hold-down plate 129.

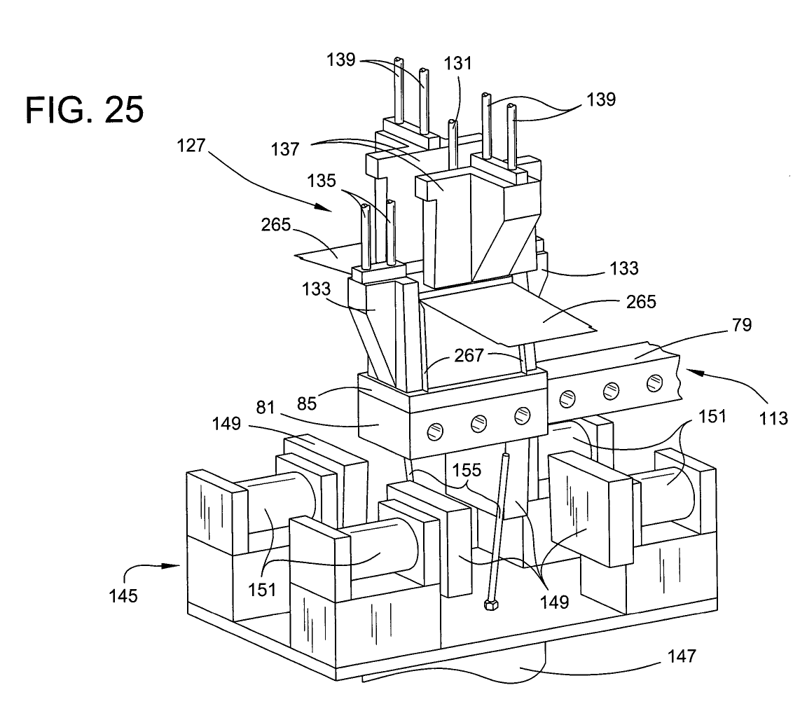

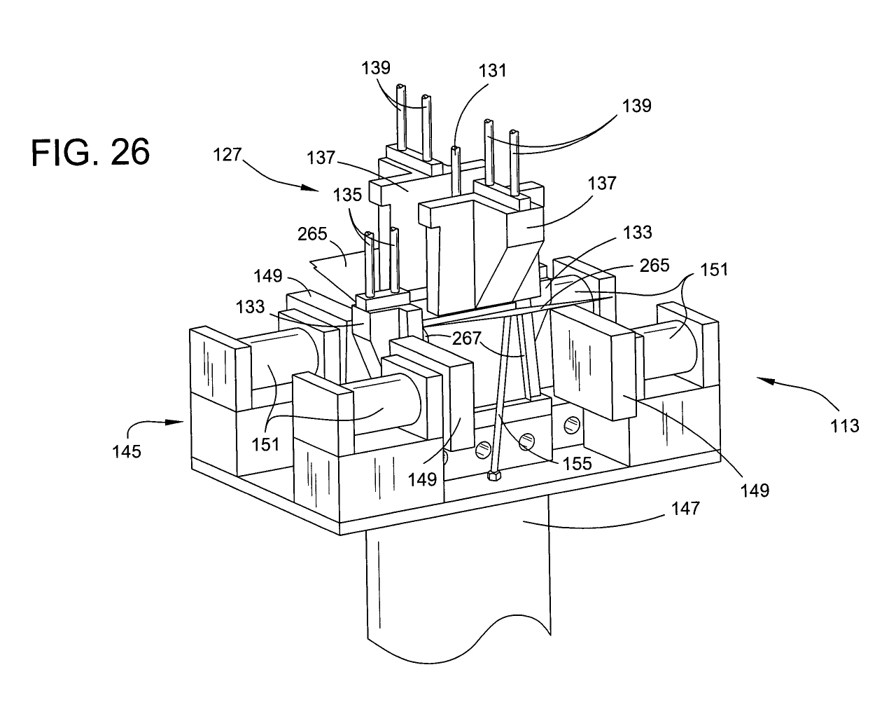

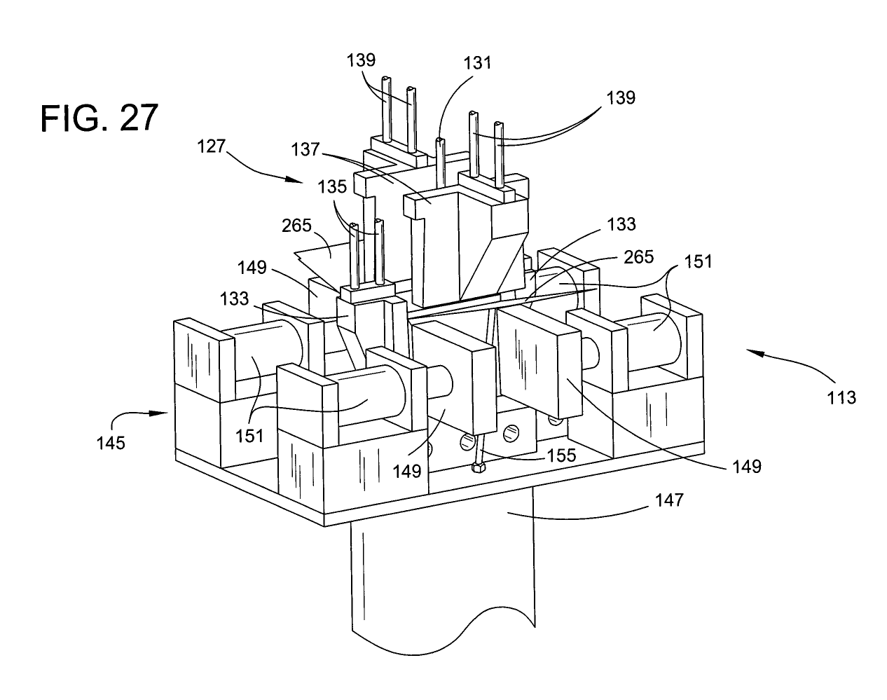

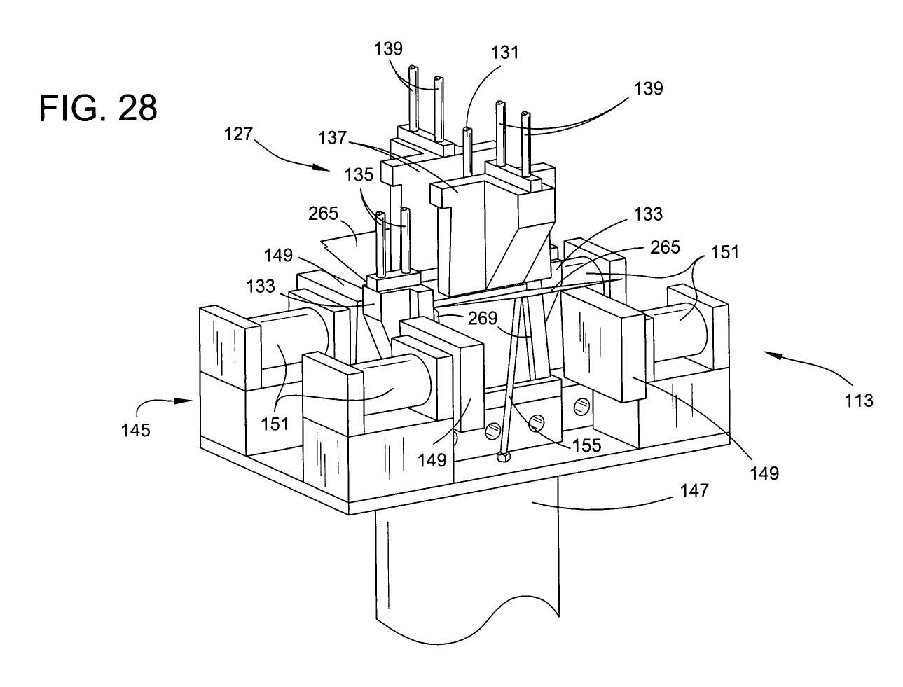

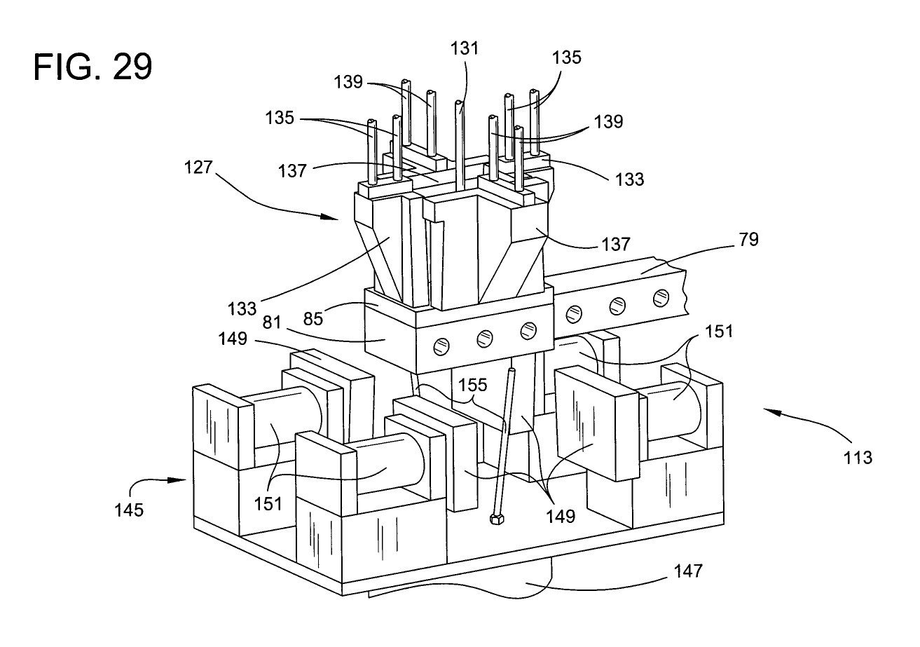

Forming of the mesh insert 25 begins when two end shaping members 133 are actuated to move down as shown in FIG. 25 to bend or fold the two end flaps 251 of the mesh blank 17 down against the end surfaces 93 of the fixture 19 to form opposing end walls 253 of the shaped mesh insert 25. Preferably, the two end flaps 251 are somewhat longer than the height H of the fixture block 87 (FIG. 14), so that as the end shaping members 133 reach the bottom of their strokes, they press the lower edge margins of the end flaps 251 against the base 85 of the fixture to form 90° flanges 257 at the lower ends of the insert end walls 253. As shown in FIG. 26, the lower frame 145 (“tab unit”) then rises to an elevated position adjacent the fixture 19. As the frame 145 rises, the push rods 155 on the frame 145 contact the two side flaps 265 of the blank 17 and push them up a short distance and out of the way for the next step to be performed. With the side flaps 265 pushed up, the two pairs of tab shaping members 149 are actuated to move inwardly toward one another and the fixture 19 to bend or fold edge portions 267 of the mesh end walls 253 against the side surfaces 91 of the fixture 19 to form corner tabs 269 or flanges along the mesh end walls 253, as shown in FIG. 27. Upon completion of their respective strokes, the tab shaping members 149 retract to their home position as shown in FIG. 28. Then the lower frame 145 returns to its lowered position. Upon arrival of the frame 145 at its lowered position, as sensed by a sensor, the two side shaping members 137 are actuated to move down as shown in FIG. 29 to bend or fold the two side flaps 265 of the mesh blank 17 down against the side surfaces 91 of the fixture 19 and over the corner tabs 269 to form opposing side walls 271 of the shaped mesh insert 25. Preferably, the two side flaps 265 are also somewhat longer than the height H of the fixture block 87, so that as the side shaping members 137 reach the bottom of their strokes, they press the lower edge margins of the side flaps 265 against the base 85 of the fixture 19 to form 90° flanges 273 at the lower ends of the insert side walls 271. A sensor signals the bottom of each stroke, after which the side shaping members 137, end shaping members 133, and hold-down plate 129 are all raised back to their home positions, as sensed by a sensor, to complete the forming cycle.

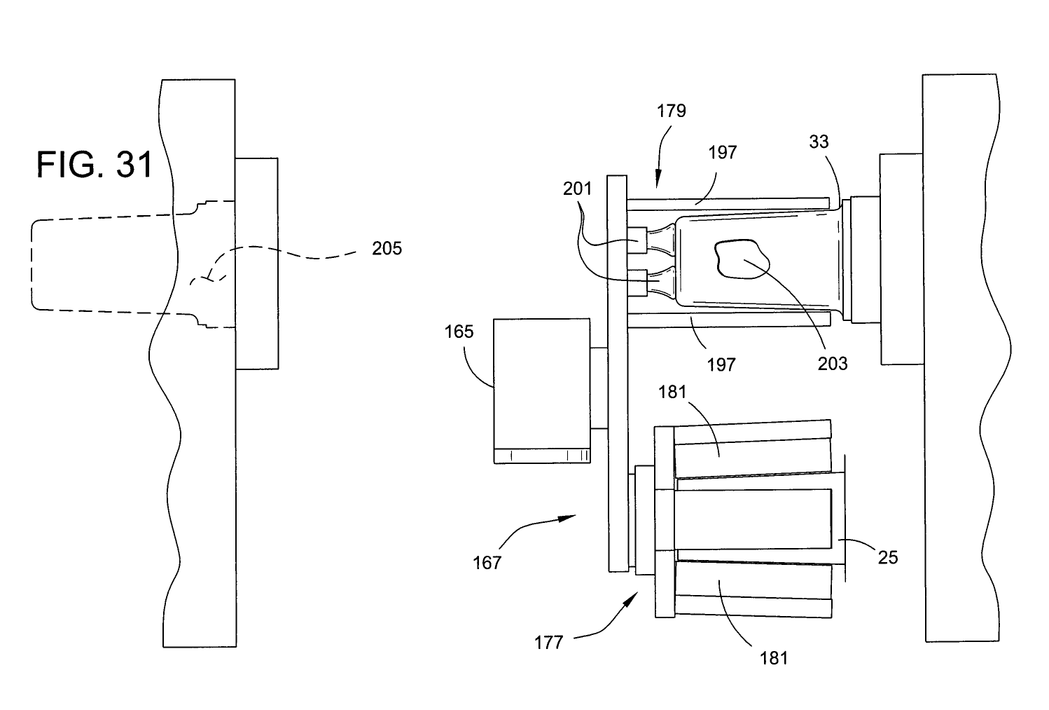

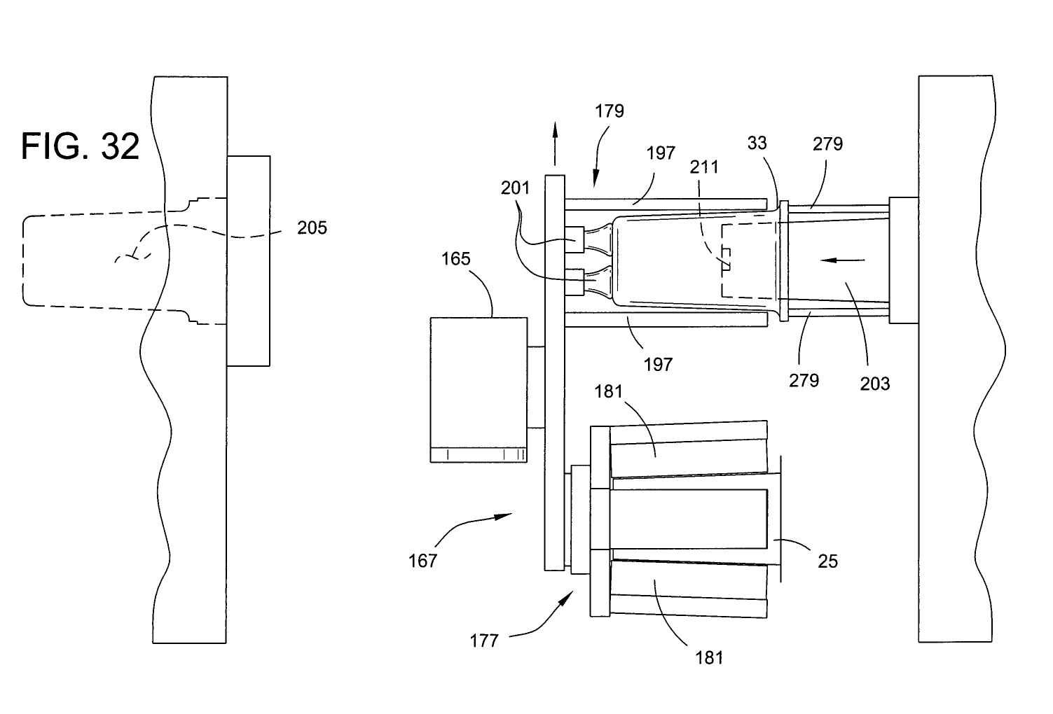

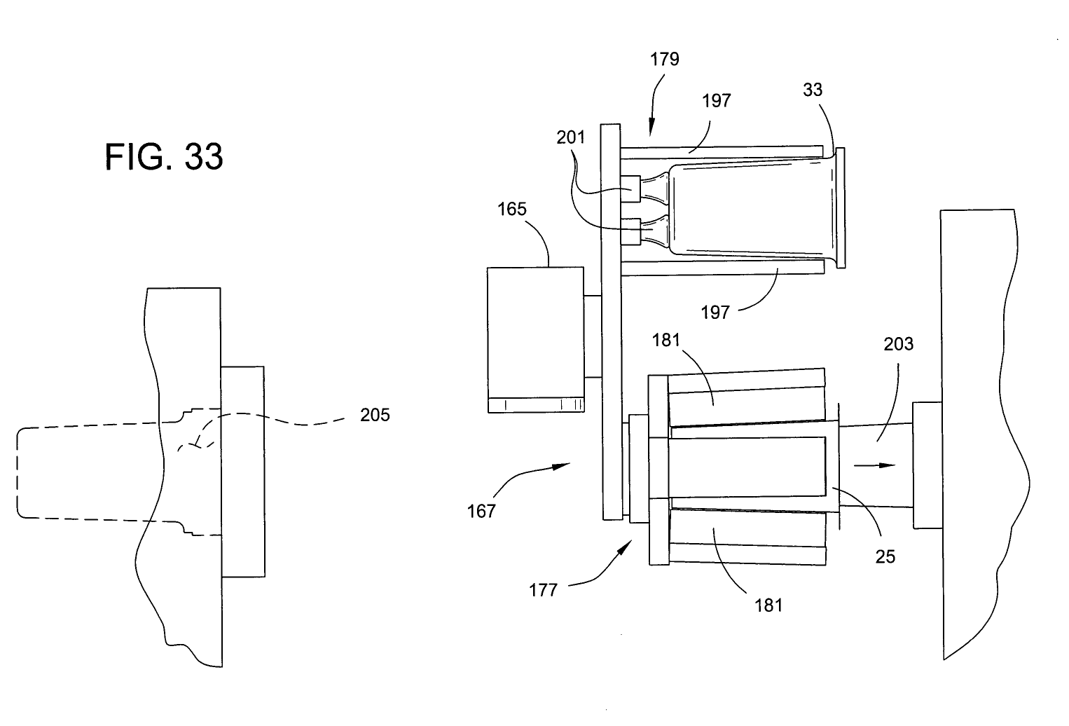

After the mesh insert 25 is formed, the hub 75 of the forming apparatus 21 (FIGS. 13 and 14) rotates to index the formed mesh 25 insert from the second (forming) station 113 to the third (loading) station 115 for pick-up by the robot 27. The robot arm 165 is activated to move the holding tool 167 to the loading station 115 to a position in which the shaped mesh insert 25 on the fixture 19 is received in the cavity 185 of the insert holder 177 and held by the magnets 181 on the tool 167. The magnets 99 on the fixture 19 are then de-energized and the arm 165 is manipulated to remove the mesh insert 25 from the fixture 25, as sensed by a sensor 105. After a predetermined interval of time sufficient to insure removal of the insert 25 from the fixture 19, a signal is sent to the control system 35 indicating that the forming apparatus 21 can continue its operation of making shaped inserts 25 from the stamped blanks 17. Assuming the molding machine 29 is ready to mold a part, as sensed by appropriate sensors and the control system 35, the robot arm 165 is maneuvered to move the holding tool 167 to a position in which the molded product holder 179 is immediately adjacent the mold core 203 which holds a freshly molded product 33, as shown in FIG. 31. Referring to FIG. 32, ejector pins 279 are then actuated to help the robot arm 165 slide the product 33 off the core 203. The molded product 33 is held by the holding tool 167 between the two holding plates 197 by the vacuum cups 201. As shown in FIG. 33, the robot arm 165 is then manipulated to shift the holding tool 167 over to a position in which the shaped mesh insert 25 is aligned with the core 203, and then advanced to place the insert 25 on the core 203, after which the magnets 181 of the holding tool 167 are de-energized and the robot arm 165 is retracted to leave the insert 25 on the core 203. The robot arm 165 then carries the molded product 33 to the product conveyance chute 221 and de-activates the vacuum cups 201 to allow the product 33 to fall into the chute 221. To complete the cycle, the robot arm 165 returns to the loading station 115 for pick-up of the next shaped mesh insert 25.

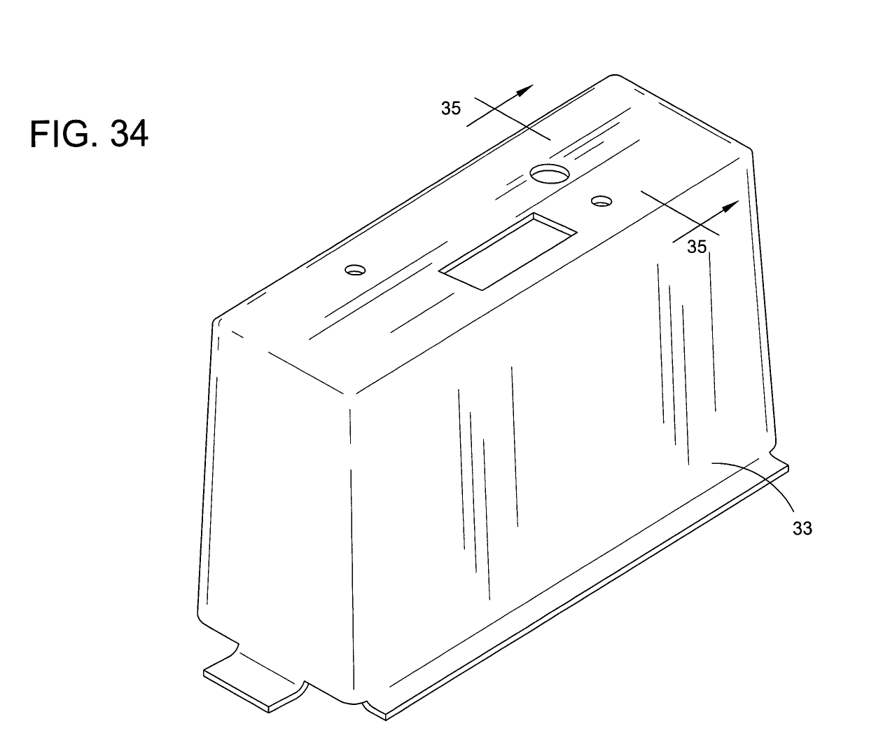

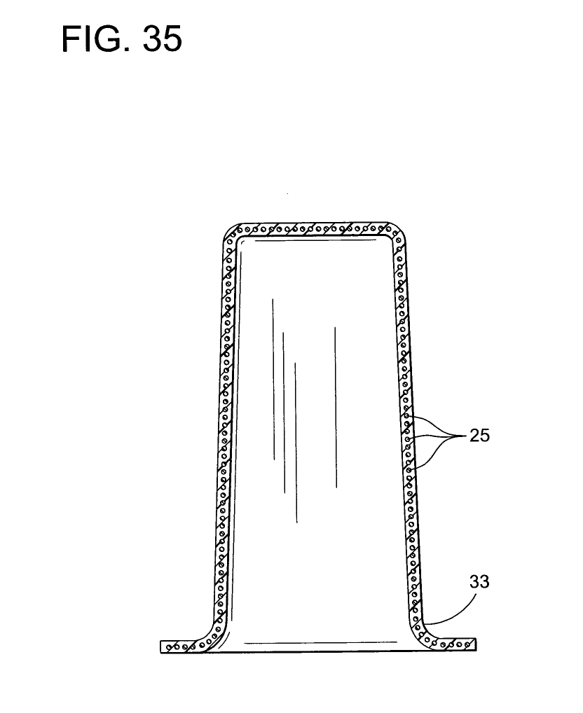

After the robot arm 165 is clear of the molding machine 29, the molding machine brings the mold core 203 and mold cavity 205 together and injects material (e.g., plastic) into the mold. Generally, the material flows into the mold and surrounds the mesh insert. FIGS. 34 and 35 show an exemplary molded product 33 that may be made using the exemplary mesh insert 25. As shown in FIG. 35, the mesh insert 25 is embedded within the molded product. Those skilled in the art will recognize that the apparatus 1 could be modified to produce any of a wide variety of mesh inserts and molded products without departing from the scope of the invention. For example, the tooling 71 at the press 15 may be altered to cut a differently-shaped blank, the fixture 19 can be shaped differently, and/or the shaping apparatus 23 can be adapted to bend the parts of the blank 17 in a different order or along different bend lines to create a mesh insert having a different shape. Also the molding machine may be adapted to change the molded product without changing the mesh insert. The apparatus 1 can shape and mold mesh inserts into practically any molded product, including automotive radio cases, computer housings, cell phones, instrument panels, housings for electric motors, and hand-held bar code scanners to name just a few.

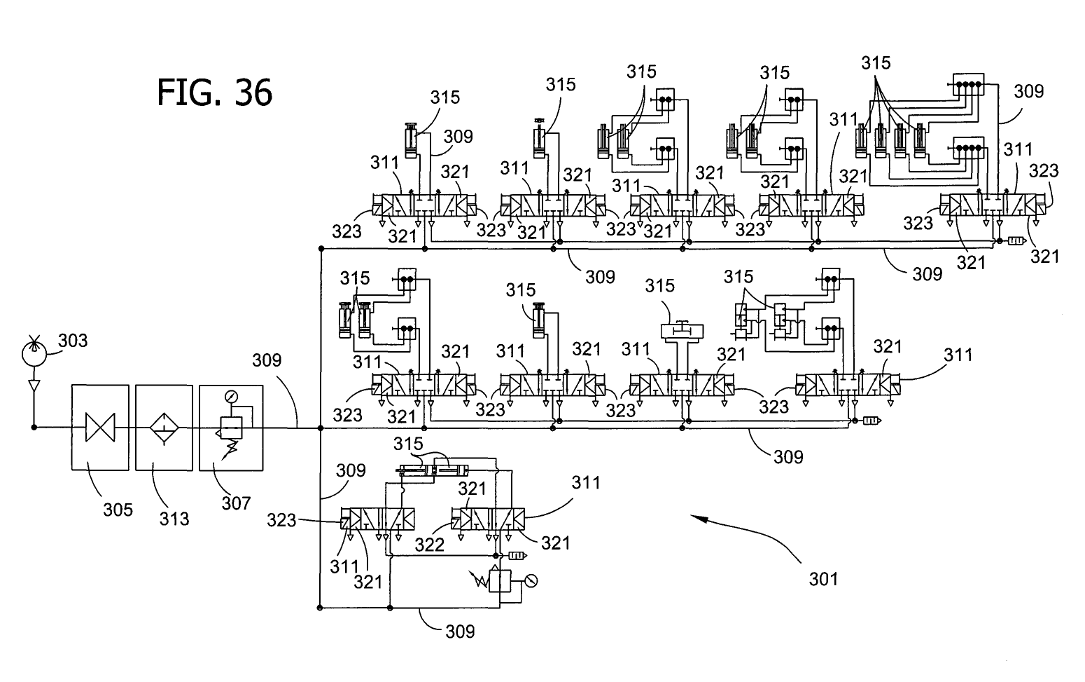

All movements of the apparatus 1 may be powered by pneumatic cylinders. FIG. 36 is a schematic representation of one suitable pneumatic circuit 301 for control of the various pneumatic cylinders that may be used to power apparatus movements. The circuit 301 itself is conventional and need not be discussed in great detail. The pneumatic circuit 301 comprises a source of compressed air 303, a lock out 305, a filter 313, a pressure regulator 307, air supply lines 309, and a plurality of operating valves 311 for supplying compressed air to the various pneumatic actuators (e.g., cylinders). Small pneumatic pistons 321, which may be activated by solenoids 323 controlled by the control system 35, can be provided to shift the spools in the operating valves 311. In this way, the control system 35 can control operation of the apparatus 1 by selectively activating and deactivating the solenoids 323, thereby directing movement of the apparatus 1 according to a programmed sequence. Those skilled in the art will recognize that the apparatus 1 could be moved by a variety of alternative mechanisms without departing from the scope of the invention.

The control system 35 (FIGS. 1-5) can also be used to selectively energize and de-energize the electromagnets 99, 181, 211 according to a programmed sequence. The previously mentioned sensors may signal the control system 35 at each step of the operational cycle to confirm that the apparatus 1 is performing properly. Alternatively, if the apparatus is not performing properly, such as if blank 17 or mesh insert 25 falls off the apparatus, the control system 35 will detect the problem based on the signals it receives from the sensors and shut the apparatus 1 down. The control system 35 may further sound an alarm to notify a person of the problem. The control system 35 also facilitates adaptation of the apparatus 1 to form a differently-shaped mesh insert 25 because the programmed sequence of apparatus 1 movements can be modified to accommodate a different bending sequence that may be used to form a mesh blank 17 into a different shape at the forming station 21. Initial and terminal sequences can also be programmed into the control system 35 to account for the absence of blanks 17, inserts 25 or molded products 33 at various phases of start-up or shut-down. Preferably, the control system 35 will have a keypad and display panel (or other user interface) to allow a person to supervise or direct operation of the apparatus 1. The control system 35 may also allow manual control of the apparatus 1, which may be desirable from time to time for user-controlled movement of the apparatus 1.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. Apparatus for manufacturing molded products to have protection against electromagnetic interference, radio frequency interference and/or electrostatic discharge, said apparatus comprising:
a fixture;
a shaping apparatus for shaping a mesh blank on said fixture into a mesh insert; and
a robot for removing the shaped mesh insert from the fixture, transferring the insert to a molding machine, and placing the insert on a mold core of the machine in preparation for a molding operation in which the mesh insert is molded into a molded product to provide said protection.

2. The apparatus as set forth in claim 1 further comprising:
a feeding apparatus for feeding a web of mesh to a stamping station; and
a press at the stamping station for cutting the blank of mesh from the web, said feeding apparatus thereafter being operable to transfer the blank to said fixture.

3. Apparatus as set forth in claim 2 further comprising a plurality of said fixtures and a forming apparatus comprising a rotatable hub having a plurality of spokes radiating out from the hub at spaced intervals around the hub, each spoke carrying at least one of said fixtures, said hub being rotatable to progressively index each fixture from said blank-receiving station to a shaping station at which said shaping apparatus is located and to a loading station at which said robot removes the mesh insert from the fixture.

4. Apparatus as set forth in claim 3 further comprising feeding apparatus for feeding a web of mesh to a stamping station and a press at the stamping station for cutting said blank of mesh from the web, said feeding apparatus thereafter being operable to place the blank on said fixture at a blank-receiving station.

5. The apparatus set forth in claim 4 wherein said feeding apparatus is operable to move the blank from the stamping station to the blank-receiving station while the trailing end of the blank is still connected to the raw web, and wherein the press is operable thereafter to sever the connection between the blank and the web.

6. The apparatus of claim 4 wherein the apparatus further comprises a programmable computer control system operable to control movement of the feeding apparatus, press, shaping apparatus, and robot, said control system being capable of being programmed to form a plurality of differently shaped mesh inserts.

7. The apparatus of claim 6 further comprising a plurality of sensors operable to send signals to the control system to signal that the apparatus has successfully completed transfer of a blank to the blank-receiving station, placement of a blank on the fixture, shaping the blank into a mesh insert, transfer of the mesh insert to a mold machine, and placement of the mesh insert on the mold core.

8. The apparatus of claim 1 further comprising a pair of locator pins extending up from the fixture for reception in a pair of holes in a mesh blank to properly locate the mesh blank on the fixture.

9. Apparatus as set forth in claim 1 wherein the fixture is equipped with magnets for holding the blank in place on the fixture.

10. Apparatus as set forth in claim 1 wherein the fixture is equipped with a sensor for sensing the correct position of the blank on the fixture.

11. The apparatus set forth in claim 1 wherein the shaping apparatus comprises one or more shaping members for bending the blank into a mesh insert.

12. The apparatus of claim 11 wherein said one or more shaping members are operable to bend a first part of the blank to form a tab and thereafter to bend a second part of blank to overlie the tab.

13. Apparatus as set forth in claim 11 wherein said shaping apparatus comprises a pair of end shaping members for bending end flaps of the blank to form end walls of the mesh insert, and a pair of side shaping members for bending side flaps of the blank to form side walls of the mesh insert.

14. Apparatus as set forth in claim 13 wherein said shaping apparatus further comprises tab shaping members for bending opposite side edge portions of the end walls to form corner tabs which tuck inside the side walls of the insert.

15. Apparatus as set forth in claim 13 wherein said shaping apparatus further comprises tab shaping members for bending opposite side edge portions of the side walls to form corner tabs which tuck inside the end walls of the insert.

16. Apparatus as set forth in claim 13 wherein said shaping apparatus further comprises at least one moveable push rod for moving a first part of the mesh blank out of the way to allow the shaping apparatus to bend a second part of the mesh blank.

17. Apparatus as set forth in claim 1 wherein said robot is operable to transfer said molded product away from the molding machine following completion of a molding operation.

18. Apparatus as set forth in claim 17 wherein the robot has an arm with a holding tool comprising a first holder for holding a mesh insert to be transferred to the molding machine, and a second holder for holding a molded product to be transferred away from the molding machine.

19. Apparatus as set forth in claim 18 wherein the first holder comprises a base and an array of electromagnets attached to the base and arranged to define a cavity for holding a mesh insert with the magnets in contact with the mesh insert.

20. Apparatus as set forth in claim 18 wherein the second holder comprises a pair of parallel plates spaced for receiving a molded product therebetween and at least one suction device between the plates.

21. A tool for use by a robot to transfer mesh inserts to a molding machine and to transfer molded products containing the mesh inserts away from a molding machine, said tool comprising:
a base;
a mesh insert holder attached to the base; and
a molded product holder attached to the base.

22. The tool set forth in claim 21 wherein the mesh insert holder comprises an array of magnets arranged to form a cavity that is shaped to receive a mesh insert.

23. The tool set forth in claim 21 wherein the molded product holder comprises a plurality of plates extending from the base, said plates being spaced apart to allow a molded product to be received between the plates, and at least one vacuum cup holder for holding the molded product.

24. The tool set forth in claim 23 wherein the mesh insert holder comprises an array of magnets arranged to form a cavity that is shaped to receive a mesh insert.

25. The tool set forth in claim 24 wherein the magnets comprise electromagnets that can be selectively energized for picking up a mesh insert and de-energized for releasing a mesh insert.

26. The tool set forth in claim 25 wherein the magnets comprise electromagnets that can be selectively energized for picking up a mesh insert and de-energized for releasing a mesh insert.

27. A method of manufacturing molded products to have protection against electromagnetic interference, radio frequency interference and/or electrostatic discharge, said method comprising:
automatically shaping a mesh blank on a fixture to form a shaped mesh insert;
operating a robot to (1) remove the mesh insert from the fixture, (2) transfer the insert to a molding machine, and (3) place the insert on a mold core of the machine in preparation for a molding operation in which the insert is molded into a molded product.

28. A method as set forth in claim 27 further comprising molding the insert into a molded product.

29. A method as set forth in claim 28 further comprising operating the robot to remove the molded product from the mold core and to transfer the product to a molded product receiving station.

30. A method as set forth in claim 27 further comprising:
automatically feeding a web of mesh to a stamping station;
automatically cutting a blank of mesh from the web at the stamping station;
automatically transferring the blank of mesh to a blank-receiving station and placing the blank on said fixture at the blank-receiving station;
automatically shaping the blank on the fixture to form a shaped insert; and
automatically transferring the shaped insert from the fixture to a molding machine using a robot.

31. A method as set forth in claim 30 further comprising molding the insert into a molded product and operating the robot to remove the molded product from the molding machine and transfer it to a molded product receiving station.

32. A method as set forth in claim 30 wherein said fixture is mounted on a spoke radiating out from a rotatable hub, said method further comprising rotating the hub to progressively index the fixture from said blank-receiving station to a shaping station where said automatic shaping of the blank occurs, and then rotating the hub to move the fixture to a loading station for removal of the insert from the fixture by said robot.

33. A method as set forth in claim 30 wherein the step of placing the blank on a fixture comprises aligning a pair of holes in the blank to fit over a pair of locator pins to properly locate the blank on the fixture.

34. A method as set forth in claim 30 further comprising energizing an electromagnet to hold the blank in position on the fixture.

35. A method as set forth in claim 30 wherein the step of shaping the blank comprises bending the blank on the fixture.

36. A method as set forth in claim 30 wherein the step of shaping the blank further comprises bending a part of the blank to form a tab and thereafter bending a second part of the blank to overlie the tab.

37. A method as set forth in claim 36 wherein the step of bending the blank to form a tab further comprises moving a part of the blank out of the way to allow bending of the tab.

38. A method as set forth in claim 30 wherein the step of shaping the blank comprises forming at least one flange.
